(19) United States
(12) Patent Application Publication
(10) Pub. No.: US 2026/0238436 A1
(43) Pub. Date: Aug. 13, 2026

(54) SRS CONFIGURATIONS OF AREA-SPECIFIC SRS FOR POSITIONING

(71) Applicant: QUALCOMM Incorporated, San Diego, CA (US)

(72) Inventors: Alexandros MANOLAKOS, Athens (GR); Mukesh KUMAR, Hyderabad (IN)

(21) Appl. No.: 19/155,543

(22) PCT Filed: Jan. 29, 2024
(86) PCT No.: PCT/US2024/013403

§ 371 Date: Aug. 11, 2025

(30) Foreign Application Priority Data
Mar. 31, 2023 (GR) 20230100272

(51) Int. Cl. H04L 5/00; H04W 64/00; H04W 76/20

(52) U.S. Cl. CPC H04L 5/0051; H04W 64/00; H04W 76/20

(57) ABSTRACT

Aspects presented herein may improve budgeting of SRS resources for SRS (pre-) configurations. In one aspect, a network entity configures, for a UE in an RRC inactive mode or RRC idle mode, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where the second set of SRSs is associated with less resource overhead compared to the first set of SRSs. The network entity transmits, for the UE, an indication of the set of SRS pre-configurations.

### CROSS-REFERENCE TO RELATED APPLICATIONS

This application claims the benefit of Greece Patent Application Serial No. 20230100272, entitled “SRS CONFIGURATIONS OF AREA-SPECIFIC SRS FOR POSITIONING” and filed on Mar. 31, 2023, which is expressly incorporated by reference herein in its entirety.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus configures, for a user equipment (UE) in a radio resource control (RRC) inactive mode or RRC idle mode, a set of sounding reference signal (SRS) pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof. The apparatus transmits, for the UE, an indication of the set of SRS pre-configurations.

In an aspect of the disclosure, a method, a computer-readable medium, and an apparatus are provided. The apparatus receives, from a network entity, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof. The apparatus transmits the first set of SRSs or the second set of SRSs based on the set of SRS pre-configurations when the UE is in an RRC inactive mode or RRC idle mode.

In an aspect of the disclosure, a method, a computer-readable medium, and an apparatus are provided. The apparatus transmits, for a second network entity, a request to generate a set of SRS pre-configurations for at least one UE according to a set of criteria, where the set of criteria includes: an interference threshold for SRS interference, a number of cells or areas to be pre-configured for the at least one UE, a first indication of whether to pre-configure a first-tier of neighboring cells or a second-tier of neighboring cells for the at least one UE, a distance of cells or areas from a serving cell to be pre-configured for the at least one UE, a second indication of whether to pre-configure pathloss (PL) for the at least one UE, a third indication of whether to pre-configure a beam spatial relation for the at least one UE, a fourth indication of whether to pre-configure a timing advance (TA) timer for the at least one UE, a fifth indication of whether to pre-configure a reference signal received power (RSRP)-change threshold for the at least one UE, or a combination thereof. The apparatus receives, from the second network entity, the set of SRS pre-configurations for the at least one UE that meets the set of criteria.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of pre-configured sounding reference signal (SRS) configurations in accordance with various aspects of the present disclosure.

FIG. 6 is a diagram illustrating an example of information elements (IEs) associated with pre-configured SRS configurations in accordance with various aspects of the present disclosure.

FIG. 7 is a diagram illustrating an example of low power high accuracy positioning (LPHAP) positioning without SRS pre-configuration in accordance with various aspects of the present disclosure.

FIG. 8 is a diagram illustrating an example of LPHAP positioning with SRS pre-configuration in accordance with various aspects of the present disclosure.

FIG. 9 is a diagram illustrating an example scenario in which multiple UEs are pre-configured with SRS configurations in accordance with various aspects of the present disclosure.

FIG. 10 is a diagram illustrating an example of pre-configuring a UE with less SRS resources (e.g., with reduced SRS overhead) for cells that are farther away from the UE in accordance with various aspects of the present disclosure.

FIG. 11 is a diagram illustrating an example of pre-configuring a UE with different SRS resources for different cells based on the mobility pattern of the UE in accordance with various aspects of the present disclosure.

FIG. 12 is a diagram illustrating an example of pre-configuring a UE with non-orthogonal SRS resources for cells that are farther away from the UE or for cells that are less likely to be accessed by the UE in accordance with various aspects of the present disclosure.

FIG. 13 is a diagram illustrating an example of pre-configuring a UE with more/multiple SRS (pre-) configurations for cells that are farther away from the UE or for cells that are less likely to be accessed by the UE in accordance with various aspects of the present disclosure.

FIG. 14 is a diagram illustrating an example of associating an expiration timer for each SRS pre-configuration in accordance with various aspects of the present disclosure.

FIG. 15 is a diagram illustrating an example of a network entity broadcasting SRS pre-configurations in accordance with various aspects of the present disclosure.

FIG. 16 is a flowchart of a method of wireless communication.

FIG. 17 is a flowchart of a method of wireless communication.

FIG. 18 is a diagram illustrating an example of a hardware implementation for an example network entity.

FIG. 19 is a flowchart of a method of wireless communication.

FIG. 20 is a flowchart of a method of wireless communication.

FIG. 21 is a diagram illustrating an example of a hardware implementation for an example apparatus and/or network entity.

FIG. 22 is a flowchart of a method of wireless communication.

FIG. 23 is a diagram illustrating an example of a hardware implementation for an example network entity.

### DETAILED DESCRIPTION

Aspects presented herein may enable a network entity (e.g., a location server, a location management function (LMF), etc.) to avoid over-budgeting sound reference signal (SRS) resources when the network entity is pre-configuring a plurality of UEs with SRS (pre-) configurations, such as UEs that are within the same cell or in neighbouring cells. Aspects presented herein may enable a network entity to pre-configure a UE with a set of SRS (pre-) configurations for a plurality of cells/areas, where each SRS (pre-) configuration in the set of SRS (pre-) configurations may be associated with different amounts/types of SRS resources that are determined based on the locations of the cells/areas and/or based on the mobility/predict pattern of the UE. As such, cells/areas that are farther away from the UE and/or are less likely to be accessed by the UE may be configured with less SRS resources or without orthogonality compared to cells/areas that are closer to the UE (or camped by the UE) and/or are more likely to be accessed by the UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

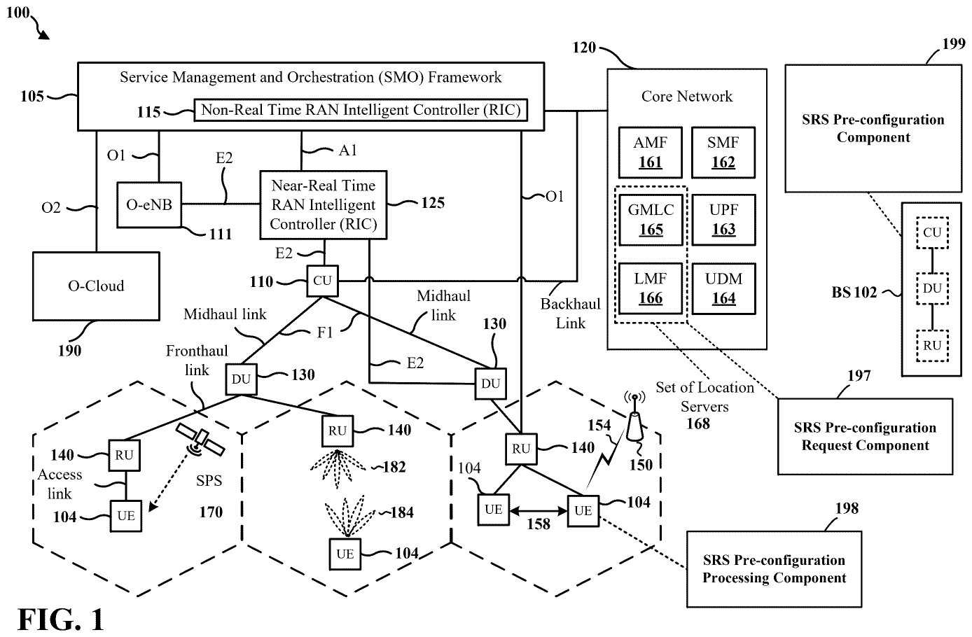

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth®, Wi-Fi® based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth® signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SRS pre-configuration processing component 198 that may be configured to receive, from a network entity, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof; and transmit the first set of SRSs or the second set of SRSs based on the set of SRS pre-configurations when the UE is in an RRC inactive mode or RRC idle mode.

In certain aspects, the base station 102 may have an SRS pre-configuration component 199 that may be configured to configure, for a UE in an RRC inactive mode or RRC idle mode, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof; and transmit, for the UE, an indication of the set of SRS pre-configurations.

In certain aspects, the one or more location servers 168 may have an SRS pre-configuration request component 197 that may be configured to transmit, for a second network entity, a request to generate a set of SRS pre-configurations for at least one UE according to a set of criteria, where the set of criteria includes: an interference threshold for SRS interference, a number of cells or areas to be pre-configured for the at least one UE, a first indication of whether to pre-configure a first-tier of neighboring cells or a second-tier of neighboring cells for the at least one UE, a distance of cells or areas from a serving cell to be pre-configured for the at least one UE, a second indication of whether to pre-configure PL for the at least one UE, a third indication of whether to pre-configure a beam spatial relation for the at least one UE, a fourth indication of whether to pre-configure a TA timer for the at least one UE, a fifth indication of whether to pre-configure an RSRP-change threshold for the at least one UE, or a combination thereof; and receive, from the second network entity, the set of SRS pre-configurations for the at least one UE that meets the set of criteria.

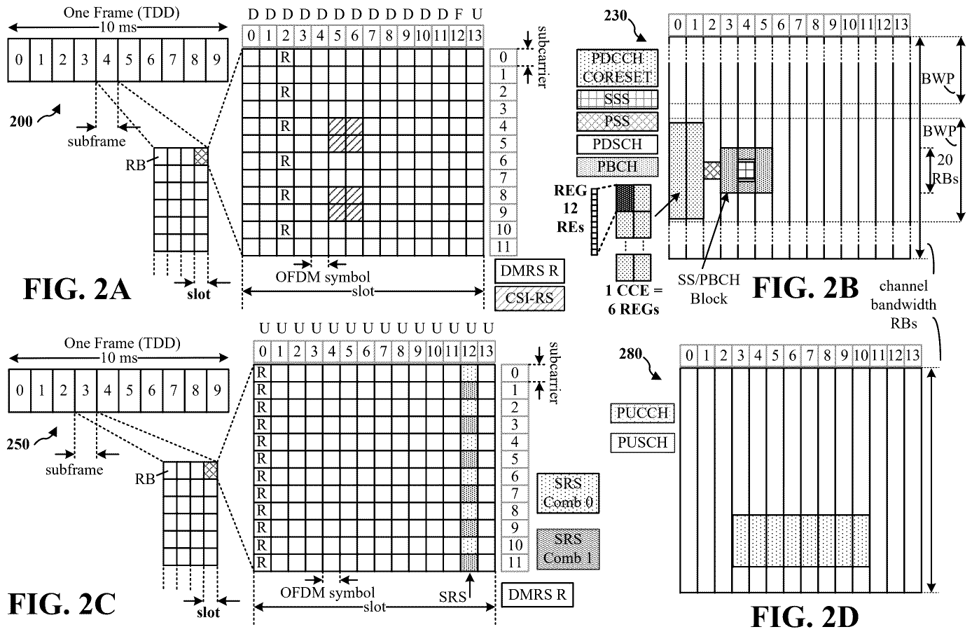

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

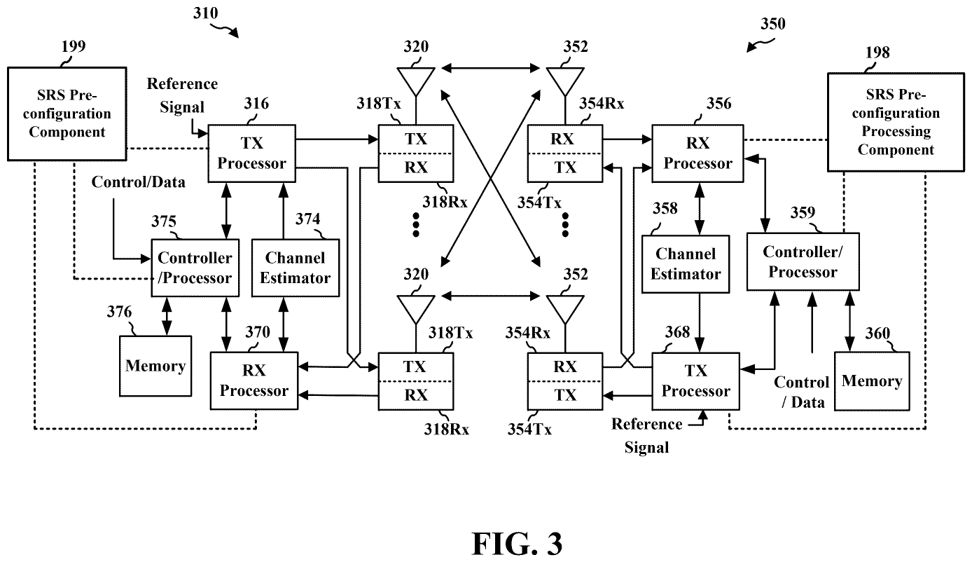

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency-domain, and then combined together using an Inverse Fast Fourier Transform (IFFT) to produce a physical channel carrying a time-domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency-domain using a Fast Fourier Transform (FFT). The frequency-domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SRS pre-configuration processing component 198 of FIG. 1.

At least one of the TX processor 316, the RX processor 370, and the controller/processor 375 may be configured to perform aspects in connection with the SRS pre-configuration component 199 of FIG. 1.

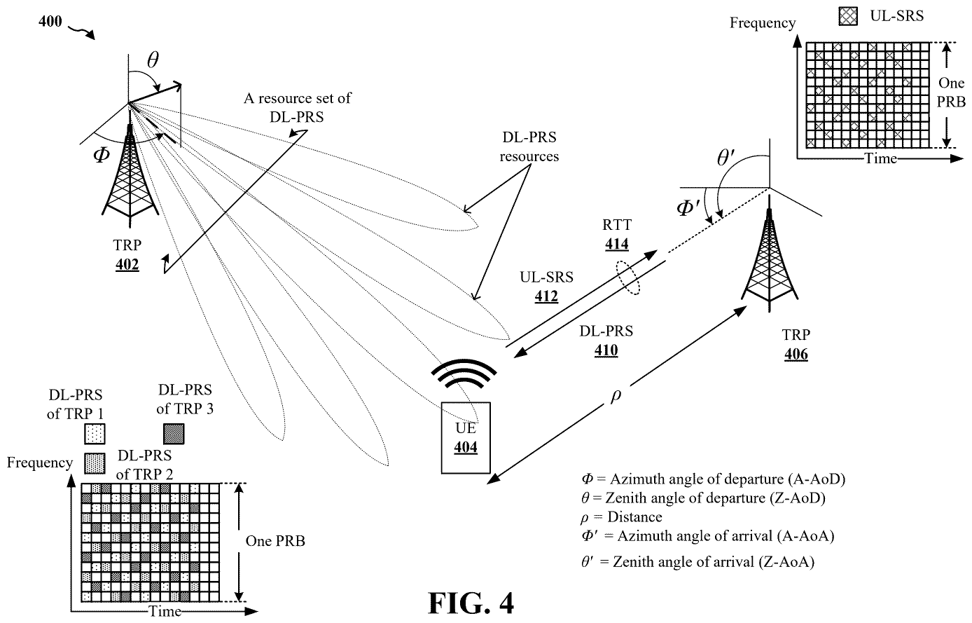

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}-T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, and/or to to determine enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In some scenarios, certain positioning devices may be specified to achieve low power high accuracy positioning (LPHAP). LPHAP provides specifications and standardizes low power high accuracy technologies for positioning terminals and services, such as for industrial Internet-of-Things (IoT) scenarios/use cases. LPHAP may support more advanced usages and applications as the wireless communications continue to evolve. For example, one goal of the LPHAP is to deliver a positioning accuracy of 90% to 0.2 meters, a latency of less than 0.1 second, and a battery life lasting at least a year. In one example, for uplink (UL) and downlink (DL)+UL positioning for UEs in a radio resource control (RRC) inactive state or RRC idle state, enhancements for enabling LPHAP may include specifying sounding reference signal (SRS) configuration enhancements based on SRS positioning validity area to avoid frequent RRC connection for SRS (re) configuration. For example, SRS for positioning configurations in multiple cells may be configured based on interference, timing advance, spatial relation information, pathloss reference and common SRS parameters across multiple, etc.

In some implementations, a UE may be pre-configured with a set of SRS configurations in which the UE may apply when the UE is under an RRC inactive/idle state. For example, like PRS Assistance Data, SRS configuration(s) may be provided to a UE (e.g., by a location server such as a location management function (LMF)), as part of an LTE positioning protocol (LPP) request or positioning system information block (SIB) broadcast. For purposes of the present disclosure, SRS pre-configuration(s) may refer to SRS configuration(s) pre-configured for a UE, which may include parameters and resources associated with transmitting SRSs (e.g., to one or more base stations/TRPs). For example, based on an SRS pre-configuration, a UE may be specified to transmit a set of SRSs to one or more base stations/TRPs using a specified time and frequency resources, bandwidth, and/or periodicity, etc. In some examples, the term “SRS pre-configuration(s)” may be used interchangeably with the term “SRS configuration(s)” for purposes of the present disclosure.

An RRC idle mode may refer to a state of a UE in which the UE is switched on but does not have any established RRC connection (e.g., with the network). No RRC connection may mean that the presence of the UE is, in general, not known to the network at the cell level because a base station may not have any context for the UE. In some examples, the location of the UE in an RRC idle mode may be known to the network at the level of tracking areas, which consist of cells. The motivation of transition a UE into an idle mode may include reducing UE power consumption by utilizing, for example, discontinuous reception. Thus, the number of processes that the UE is specified to perform in the RRC idle mode may be significantly smaller than in RRC connected mode. The term “camp on” may be used when UE behaviors in an RRC idle mode are described. “Camp on” may refer to a UE state in which the UE stays on a cell and is ready to initiate a potential dedicated service or to receive an ongoing broadcast service. An RRC inactive mode may be similar or the same as an RRC idle mode, with the exception that the UE may store an RRC context for certain period of time in some examples. After some timer expiry, the UE may just delete that context and move to an RRC idle mode. In some implementations, there may also be additional RRC mode(s)/state(s) between the RRC connected mode and the RRC idle mode, where the network and/or the UE may optionally stay in an RRC inactive mode without completely releasing the RRC when there is no traffic and quickly switch back to the RRC connected mode when specified. In this mode/state, the UE may be put in a dormant state which does not do any data transmission, but NAS layer may remain connected and RRC may not be completely released. In some examples, this special state may be referred to as RRC inactive state/mode.

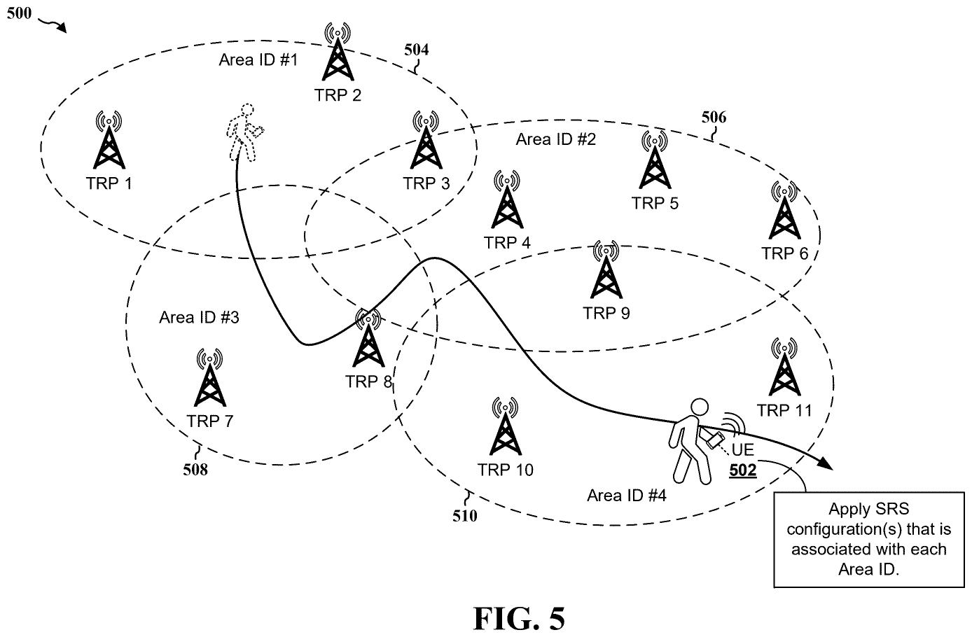

FIG. 5 is a diagram 500 illustrating an example of pre-configured SRS configurations in accordance with various aspects of the present disclosure. In one aspect, a pre-configured SRS may consist of multiple SRS configurations, where each SRS configuration may be applicable to a different area within the network. Under the concept of SRS validity area, a UE 502 may use/apply an SRS configuration within area validity of area identification (ID), where an area ID may consist of one and multiple cells.

For example, as shown at 504, a first set of transmission reception points (TRPs) (e.g., TRPs #1, 2, and 3) may be associated with a first area ID (Area ID #1); as shown at 506, a second set of TRPs (e.g., TRPs #3, 4, 5, 6, and 9) may be associated with a second area ID (Area ID #2); as shown at 508, a third set of TRPs (e.g., TRPs #7 and 8) may be associated with a third area ID (Area ID #3); and as shown at 510, a fourth set of TRPs (e.g., TRPs #9, 10, and 11) may be associated with a fourth area ID (Area ID #4), etc. In one example, if a UE 502 is pre-configured with a set of SRS configurations, the UE 502 may be specified to apply different SRS configurations based on the area ID associated with the current location of the UE 502. In addition, the UE 502 may be under an RRC inactive/idle state when applying the SRS configuration(s). For example, when the UE 502 is within the area associated with the first area ID, the UE 502 may apply an SRS configuration that corresponds to the first area ID, such as transmitting a set of SRSs to TRP(s) #1, 2, and/or 3 using specified time resources, frequency resources, periodicity, bandwidth, etc. Similarly, when the UE 502 is within the area associated with the fourth area ID, the UE 502 may apply another SRS configuration that corresponds to the fourth area ID, such as transmitting a set of SRSs to TRP(s) #9, 10, and/or 11 using specified time resources, frequency resources, periodicity, bandwidth, etc. As such, the SRS configuration associated with each area ID may be different.

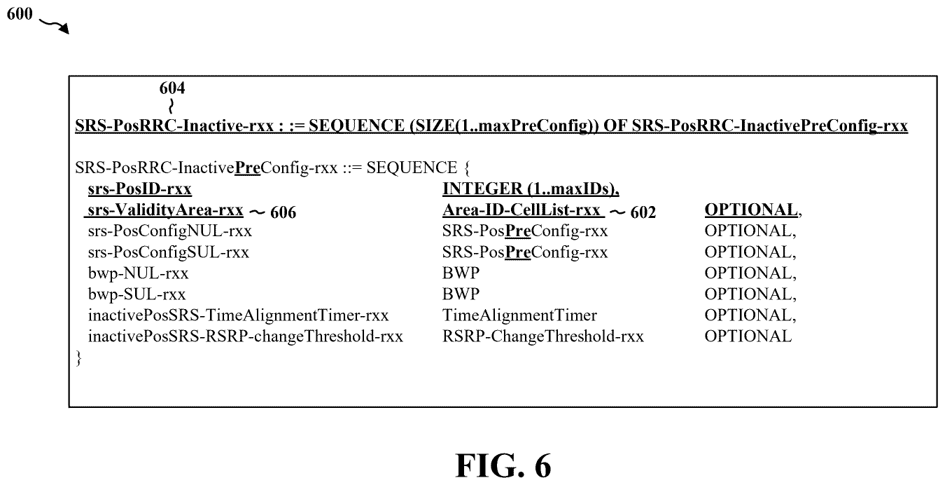

FIG. 6 is a diagram 600 illustrating an example of information elements (IEs) associated with pre-configured SRS configurations in accordance with various aspects of the present disclosure. In one example, to enable more network control over the positioning SRS transmission after cell reselection, as shown at 602, an LPP Area-ID-CellList parameter/IE may be added to a (pre-) configured positioning SRS. Compared to a DL-PRS assistance data validity, the Area-ID-CellList parameter for positioning SRS may be UE specific. If a UE (e.g., the UE 502) camps on a cell whose ID is included in the Area-ID-CellList parameter, then the UE may be permitted to continue the (associated) positioning SRS transmission in the new cell after cell reselection.

As shown at 604, an SRS-PosRRC-Inactive parameter may be used to provide a set of up to a maximum pre-configuration (maxPreConfig) positioning SRS configurations, where each configuration can be identified by an SRS positioning ID (srs-PosID). As shown at 606, the srs-ValidityArea parameter may be used for providing a list of Cell IDs where this SRS configuration is valid. If a UE reselects to a cell included in the Area-ID-CellList parameter, the UE is permitted to continue SRS transmission during and/or after the cell reselection. In some examples, the Area-ID-CellList parameter may not coincide with a radio access network (RAN)-based notification area (RNA) and may be a dedicated, UE-specific, UL positioning area. Such configuration, may avoid SRS interruption at cell reselection, which may reduce the amount of SRS configuration signalling specified and reduce the latency, and hence providing power consumption at a target device (e.g., a UE).

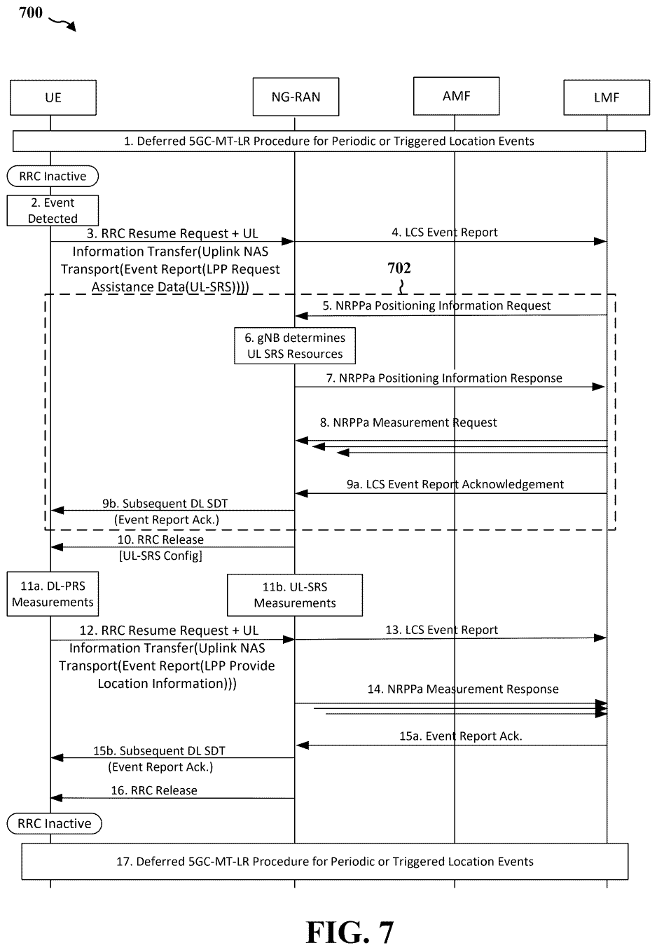

FIG. 7 is a diagram 700 illustrating an example of LPHAP positioning without SRS pre-configuration in accordance with various aspects of the present disclosure. In one example, if a UE in an RRC inactive/idle state is specified/triggered to transmit a set of SRSs (e.g., for a UE positioning session) but the UE is not pre-configured with SRS configurations (e.g., SRS pre-configurations) for transmitting the set of SRSs, the UE may be specified to transition into an RRC connected state (e.g., at step 3) to receive SRS configurations from an LMF (e.g., via a serving base station).

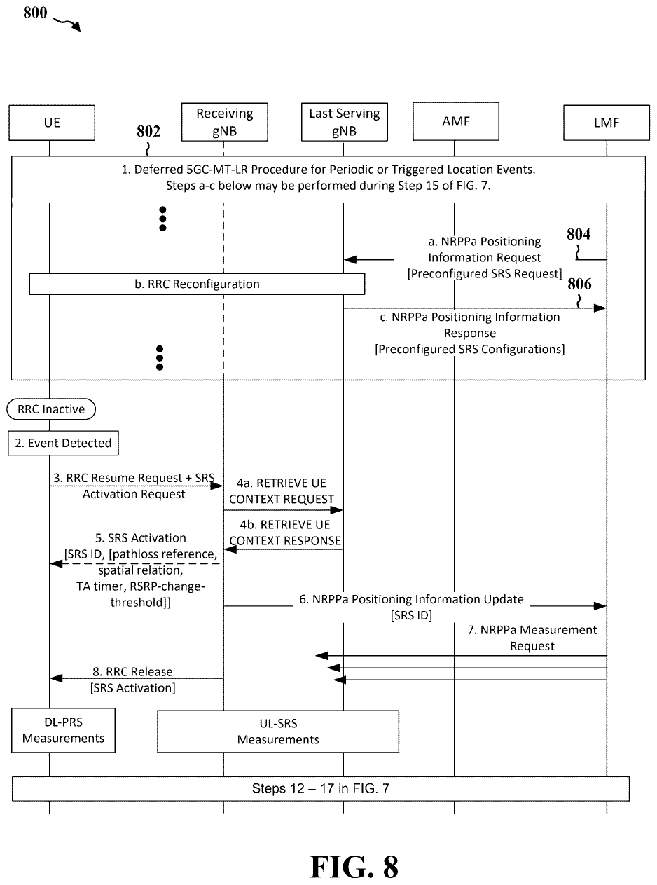

FIG. 8 is a diagram 800 illustrating an example of LPHAP positioning with SRS pre-configuration in accordance with various aspects of the present disclosure. As shown at 802, a UE may be pre-configured with a set of SRS configurations when the UE is in an RRC connected mode (e.g., before transition into an RRC inactive/idle mode). Then, after the UE transitions into the RRC inactive/idle mode and is specified to transmit SRSs, the UE may apply the SRS configuration(s) in the set of SRS configurations, such as described in connection with FIG. 5. Under such configuration, the UE is not specified to transition to an RRC connected mode, which may reduce the latency of the SRS configuration and thereby improving power consumption at the UE. In other words, as shown at 702 of FIG. 7, signaling for SRS configuration that is associated with steps 5, 6, 7, and 9 in FIG. 7 may not be specified and may be avoided if the UE is pre-configured with SRS configurations.

Table 2 below shows an example of specified SRS transmission characteristics, where an IE may be configured to include specified SRS configuration(s) for a UE.

TABLE 2
Example of Specified SRS Transmission Characteristics

| | | | IE Type and | Semantics |
|---|---|---|---|---|
| IE/Group Name | Presence | Range | Reference | Description |
| Number Of | C- | | INTEGER | The number of |
| Periodic | ifResourceTypePeriodic | | (0 . . . | periodic SRS |
| Transmissions | | | 500, . . .) | transmissions |
| | | | | requested. The |
| | | | | value of ‘0’ |
| | | | | represents an |
| | | | | infinite number |
| | | | | of periodic SRS |
| | | | | transmissions. |
| Resource Type | M | | ENUMERATED | |
| | | | (periodic, semi- | |
| | | | persistent, | |
| | | | aperiodic, . . .) | |
| CHOICE | M | | | |
| Bandwidth | | | | |
| >FR1 | | | ENUMERATED | |
| | | | (5 mHz, 10 mHz, | |
| | | | 20 mHz, 40 mHz, | |
| | | | 50 mHz, 80 mHz, | |
| | | | 100 mHz, . . .) | |
| >FR2 | | | ENUMERATED | |
| | | | (50 mHz, 100 | |
| | | | mHz, 200 mHz, | |
| | | | 400 mHz, . . .) | |
| SRS Resource Set | | 0 . . . 1 | | |
| List | | | | |
| >SRS Resource | | 1 . . . <maxnoSRS- | | |
| Set Item | | ResourceSet> | | |
| >>Number of | O | | INTEGER | The number of |
| SRS Resources | | | (1 . . . | SRS Resources |
| Per Set | | | 16, . . .) | per resource |
| | | | | set for SRS |
| | | | | transmission. |
| >>Periodicity | | 0 . . . 1 | | |
| List | | | | |
| >>>Periodicity | | 1 . . . <maxnoSRS- | | |
| List Item | | ResourcePerSet> | | |
| >>>>PeriodicitySRS | M | | ENUMERATED | Milli-seconds |
| | | | (0.125, 0.25, 0.5, | |
| | | | 0.625, 1, 1.25, 2, | |
| | | | 2.5, 4, 5, 8, 10, | |
| | | | 16, 20, 32, 40, 64, | |
| | | | 80, 160, 320, 640, | |
| | | | 1280, 2560, 5120, | |
| | | | 10240, . . .) | |
| >>Spatial | O | | 9.2.34 | |
| Relation | | | | |
| Information | | | | |
| >>Pathloss | O | | 9.2.53 | |
| Reference | | | | |
| Information | | | | |
| SSB Information | O | | 9.2.54 | |
| SRS Frequency | O | | INTEGER(0 . . . | NR ARFCN |
| | | | 3279165) | The carrier |
| | | | | frequency |
| | | | | of SRS |
| | | | | transmission |
| | | | | bandwidth. |

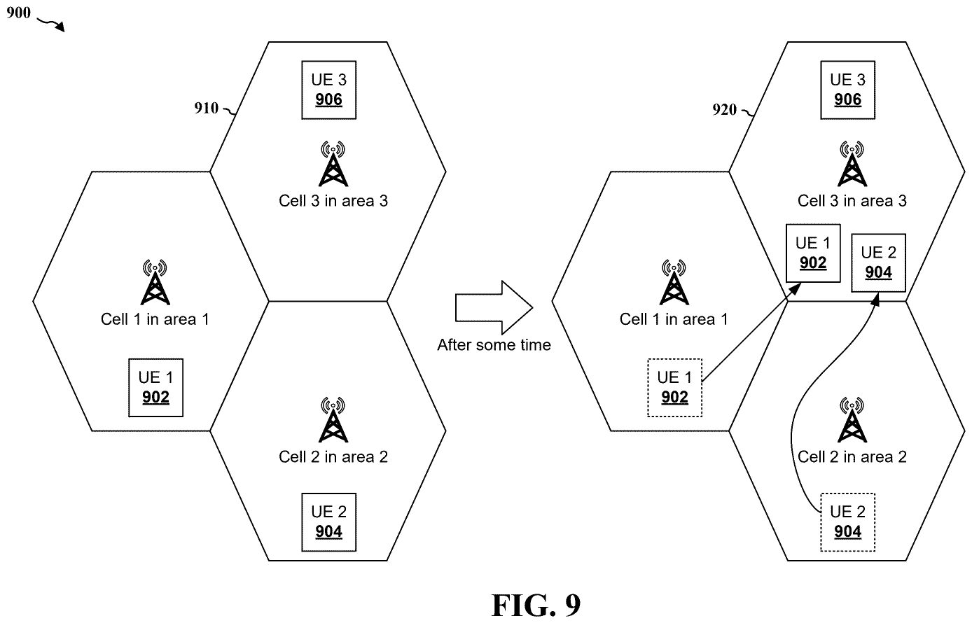

FIG. 9 is a diagram 900 illustrating an example scenario in which multiple UEs are pre-configured with SRS configurations in accordance with various aspects of the present disclosure. In some scenarios, while pre-configuring a UE with SRS configurations may improve the latency and power consumption for the UE during US positioning, it may also impact the efficiency of using/allocating SRS resources when a number of UEs are pre-configured with SRS configurations.

For example, as shown at 910, a first UE 902 (UE 1) that is initially camped on a first cell (Cell 1) in a first area (e.g., an area associated with a first area ID) may be pre-configured with a set of SRS configurations that includes SRS configurations for the first area, a second area (e.g., an area associated with a second area ID), and a third area (e.g., an area associated with a third area ID), etc. A second UE 904 (UE 2) that is initially camped on a second cell (Cell 2) in the second area may also be pre-configured with a set of SRS configurations that includes SRS configurations for the first area, the second area, and the third area, etc. Similarly, a third UE 906 (UE 3) that is initially camped on a third cell (Cell 3) in the third area may also be pre-configured with a set of SRS configurations that includes SRS configurations for the first area, the second area, and the third area, etc. For purposes of the present disclosure, when a UE camps on a cell, it may refer to a procedure in which the UE searches for a suitable cell of a selected public land mobile network (PLMN) (e.g., during/with cell selection), and chooses that cell to provide available services, and monitors its control channel. In some examples, the UE may choose a cell based on a received signal quality metric (e.g., measuring the synchronization signal block (SSB), determining the SSB-RSRP, and picking the cell with the highest RSRP, etc.).

In one example, as shown at 920, when the first UE 902, the second UE 904, and the third UE 906 are in an RRC inactive/idle state, there is a possibility that the first UE 902 and the second UE 904 may move to the third area. Thus, when each UE is pre-configured with corresponding SRS configurations (while the UEs are RRC connected to the network), the network may assign an SRS resource associated with each of the cells in which each UE may camp on. For example, the network may assign the first UE 902, the second UE 904, and the third UE 906 with a first set of SRS resources (SRS 1), a second set of SRS resources (SRS 2), and a third set of SRS resources (SRS 3), respectively, when/if they move to the third area (e.g., Cell 3). Thus, if the first UE 902 moves to the third area (e.g., camped on Cell 3), the first UE 902 may transmit a set of SRS resources using the first set of SRS resources. Similarly, if the second UE 904 moves to the third area (e.g., camped on Cell 3), the second UE 904 may also transmit a set of SRS resources using the second set of SRS resources.

However, if the first UE 902 and/or the second UE 904 never move to the third area (e.g., Cell 3), then the SRS resources (e.g., the first set of SRS resources and the second set of SRS resources) pre-configured for the first UE 902 and/or the second UE 904 may be occupied by the first UE 902 and/or the second UE 904 without being used, which may result in a loss of SRS capacity (e.g., the network may not be able to configure SRS resources for other UEs). Imagine a worst-case scenario where there is a 57-cell layout and each cell has 10 active UEs, pre-configuring each UE with an orthogonal SRS resources for each potential cell they may camp on may result the 10 UEs in each cell occupying 10×57=570 SRS resources. This may lead to an over-budgeting of SRS resources and SRS configurations.

Aspects presented herein may enable a network entity (e.g., a location server, an LMF, etc.) to avoid over-budgeting SRS resources when the network entity is pre-configuring a plurality of UEs with SRS (pre-) configurations, such as UEs that are within the same cell or in neighbouring cells. Aspects presented herein may enable a network entity to pre-configure a UE with a set of SRS (pre-) configurations for a plurality of cells/areas, where each SRS (pre-) configuration in the set of SRS (pre-) configurations may be associated with different amounts/types of SRS resources that are determined based on the locations of the cells/areas and/or based on the mobility/predict pattern of the UE. As such, cells/areas that are farther away from the UE and/or are less likely to be accessed by the UE may be configured with less SRS resources or without orthogonality compared to cells/areas that are closer to the UE (or camped by the UE) and/or are more likely to be accessed by the UE.

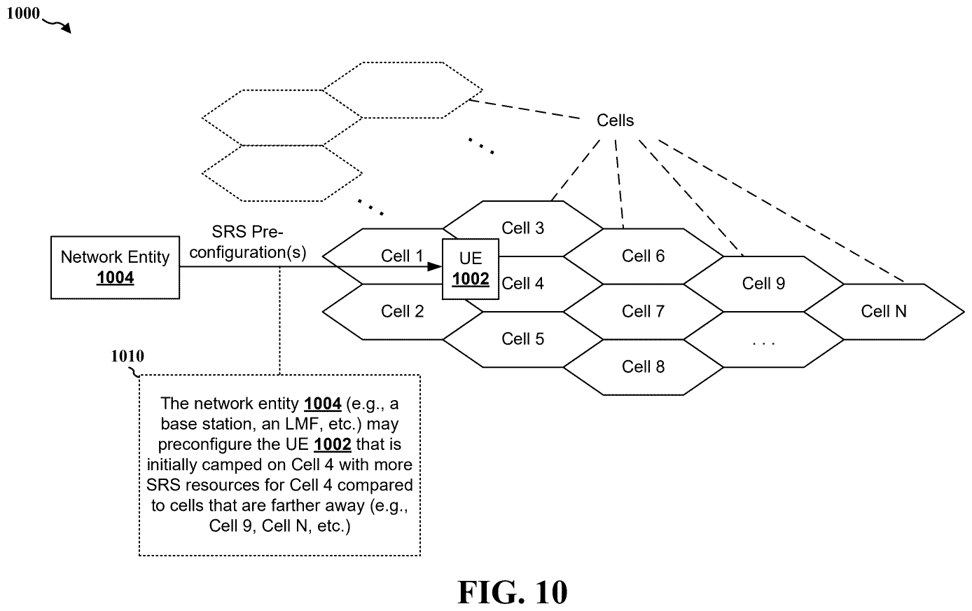

FIG. 10 is a diagram 1000 illustrating an example of pre-configuring a UE with less SRS resources (e.g., with reduced SRS overhead) for cells that are farther away from the UE in accordance with various aspects of the present disclosure. In one aspect of the present disclosure, to prevent a network entity from over-budgeting SRS resources associated with SRS pre-configurations, the network entity may pre-configure a UE with less SRS resources or with reduced SRS overhead for farther-away cells.

In one example, as shown at 1010, in the pre-configuration of SRS, a network entity 1004 (e.g., a base station, a location server, an LMF, etc.) may assign to a UE 1002 that is initially camped to Cell 4 a first set of SRS resources (SRS-resource1), and the network entity may also assign to the UE 1002 a second set of SRS resources (SRS-resource2) to be used by the UE 1002 if the UE camps on Cell 9 and/or Cell N, where the second set of SRS resources may have smaller overhead compared to the first set of SRS resources. For example, the second set of SRS resources may be associated with a larger SRS periodicity (e.g., the UE 1002 may be configured to transmit an SRS every 20 milliseconds (ms) in Cell 9, and transmit an SRS every 5 ms in Cell 4, etc.), and/or the second set of SRS resources may be associated with a smaller number of symbols (e.g., the UE 1002 may be configured to transmit an SRS using 4 symbols in Cell 9, and transmit an SRS using 8 symbols in Cell 4, etc.).

As described in connection with FIG. 9, pre-configuring a full-fledged SRS resources for cells in which a UE is less likely to move to (e.g., the farther-away cells) may cause over-budgeting of SRS resources (e.g., if the UE never moves to these cells). In other words, in an unlikely event that there is a sudden flow/mobility of UEs pre-configured with SRS (pre-) configurations towards any given cell (e.g., 10 UEs in Cell 4 moves to Cell 9 at the same time), since all of these UEs are configured with a low-overhead SRS to be used for the reselected cell (e.g., for Cell 9), the SRS capacity in that cell is less likely to deteriorate significantly.

In another example, the network entity 1004 may pre-configure the UE 1002 with a first set of SRS resources (e.g., with a first set of SRS pre-configurations) that is to be applied to a first set of cells that is closer to the UE 1002, and the network entity 1004 may also pre-configure the UE 1002 with a second set of SRS resources (e.g., with a second set of SRS pre-configurations) that is to be applied to a second set of cells that is farther away from the UE 1002 compared to the first set of cells, where the second set of SRS resources have lower SRS overhead compared to the first set of SRS resources. For example, the first set of cells may include the cell in which the UE 1002 (e.g., Cell 4) and its direct/immediate neighbouring cells (e.g., Cells 1, 2, 3, 5, 6, and 7, etc.), and the second set of cells may correspond to the rest of cells (e.g., Cells 9 to N).

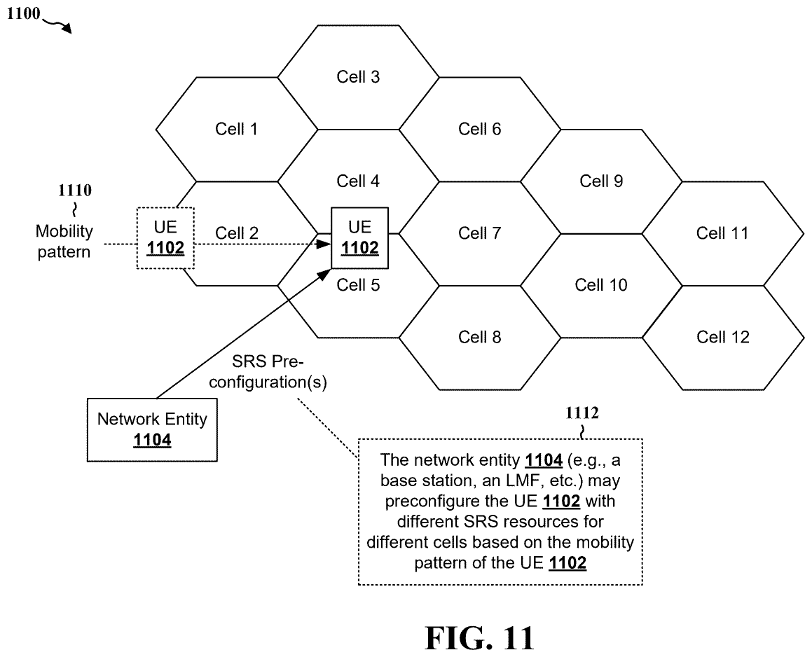

FIG. 11 is a diagram 1100 illustrating an example of pre-configuring a UE with different SRS resources for different cells based on the mobility pattern of the UE in accordance with various aspects of the present disclosure. In another aspect of the present disclosure, to prevent a network entity from over-budgeting SRS resources associated with SRS pre-configurations, the network entity may pre-configure a UE with less SRS resources or with reduced SRS overhead for cells in which the network entity predicts the UE is less likely to move to. In other words, the network entity may take into account previous recorded/collected mobility pattern(s) of the UE to determine the likelihood of the UE pre-configured with the area-specific SRS appear on cells/areas farther away from the initial cell. In some examples, this information may be received by a location server (e.g., an LMF), or by a corresponding network entity (e.g., a 5G network data analytics function (NWDAF)), etc.

For example, as shown at 1110, a network entity 1104 (e.g., a base station, an LMF, etc.) may detect that a UE 1002 is moving in a direction from Cell 2 to Cell 5, and may predict that the UE 1002 is likely to continue moving towards the same direction, such as towards Cells 7, 8, 9, 10, 11, and 12, etc. Thus, as shown at 1112, when the network entity 1104 pre-configures the UE 1002 with SRS pre-configurations for Cells 1 to 12, the network entity 1104 may allocate/assign more resource overheads for cells that are more likely to be accessed by the UE 1002 (e.g., Cells 7, 8, 9, 10, 11, and 12, etc.), and allocate/assign less resource overheads for cells that are less likely to be accessed by the UE 1002 (e.g., Cells 1, 2, 3, and 6, etc.). As such, even though both Cell 2 and Cell 7 are neighbouring cells of Cell 5 in which the UE 1002 may be currently camped on, the network entity 1104 may pre-configure more SRS resources for Cell 7 compared to Cell 2 as the UE 1002 is more likely to access Cell 7 compared to Cell 2.

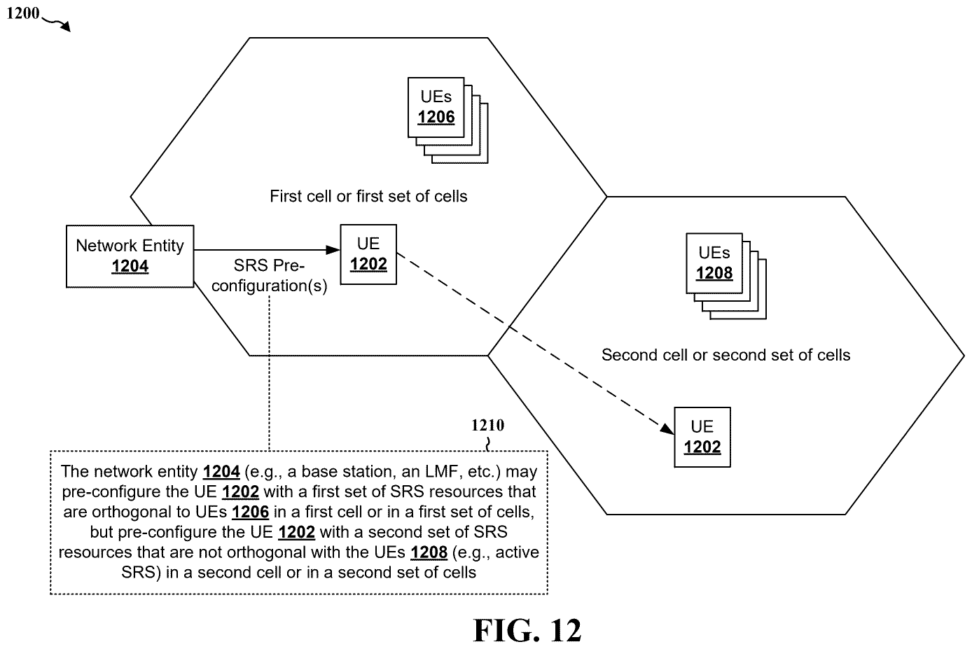

FIG. 12 is a diagram 1200 illustrating an example of pre-configuring a UE with non-orthogonal SRS resources for cells that are farther away from the UE or for cells that are less likely to be accessed by the UE in accordance with various aspects of the present disclosure. In one aspect of the present disclosure, to prevent a network entity from over-budgeting SRS resources associated with SRS pre-configurations, the network entity may pre-configure a UE with non-orthogonal SRS resources for farther-away cells or for cells that are less likely to be accessed by the UE (e.g., predicted by the network entity based on the previous mobility pattern of the UE).

In one example, as shown at 1210, in the pre-configuration of SRS, a network entity 1204 (e.g., a base station, a location server, an LMF, etc.) may assign to a UE 1202 that is initially camped on a first cell or on one cell of a first set of cells a first set of SRS resources (SRS-resource1) that is orthogonal with UE(s) 1206 that are also in the first cell or in the first set of cells at that time. Then, the network entity 1204 may also assign the UE 1202 with a second set of SRS resources (SRS-resource2) to be used by the UE 1202 if the UE 1202 camps on a second cell or on one cell of a second set of cells, where the second set of SRS resources are not orthogonal with the UEs 1208 that are in the second cell or in the second set of cells.

As described in connection with FIGS. 10 and 11, the second cell or the second set of cells may be cell(s) that are farther away from the UE 1202 or cell(s) predicted by the network entity 1204 to be less likely accessed by the UE 1202 compared to the first cell or the first set of cells. Thus, as there is a lower likelihood for the UE 1202 to move to the second cell or the second set of cells, the network entity 1204 may configure the UE 1202 with non-orthogonal/colliding SRS resources for the second cell or the second set of cells to reduce budgeting for SRS resources. Similarly, as described in connection with FIG. 11, the network entity 1204 may take into account previous recorded/collected mobility patterns to determine the likelihood of the UE 1202 pre-configured with area-specific SRS appear on cells/areas farther away from the initial cell. This information may be received by the LMF, or by a corresponding network entity (e.g., a 5G NWDAF).

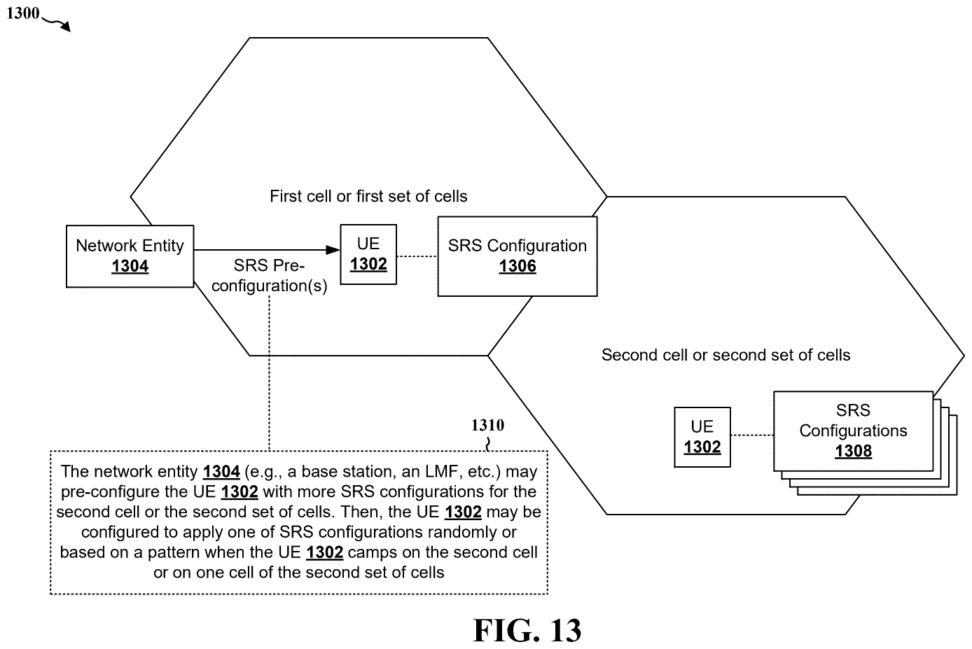

FIG. 13 is a diagram 1300 illustrating an example of pre-configuring a UE with more/multiple SRS (pre-) configurations for cells that are farther away from the UE or for cells that are less likely to be accessed by the UE in accordance with various aspects of the present disclosure. In one aspect of the present disclosure, to prevent a network entity from over-budgeting SRS resources associated with SRS pre-configurations, the network entity may pre-configure a UE with more or multiple SRS (pre-) configurations for farther-away cells or for cells that are less likely to be accessed by the UE (e.g., predicted by the network entity based on the previous mobility pattern of the UE), where each SRS (pre-) configuration may be associated with different SRS resource allocation (e.g., using different bandwidths, time/frequency resources, periodicity, etc.). Then, in the event that the UE moves to these cells (e.g., the farther-away cells or the less likely accessed cells), the UE may be configured to select and apply one of the SRS (pre-) configurations.

For example, as shown at 1310, in the pre-configuration of SRS, a network entity 1304 (e.g., a base station, a location server, an LMF, etc.) may pre-configure a UE 1302 with an SRS configuration 1306 in which the UE 1302 may apply when the UE 1302 camps on a first cell or on one cell of a first set of cells. Then, the network entity 1304 may also pre-configure the UE 1302 with a plurality of SRS configuration 1310 in which the UE 1302 may apply when the UE 1302 camps on a second cell or on one cell of a second set of cells. Then, if the UE 1302 moves to the second cell or to one cell in the second set of cells, the UE 1302 may be configured to select and apply one of the SRS configurations 1308 randomly or with a specified pattern (e.g., a round-robin pattern) to avoid constant interference caused by the UE 1302 using the same SRS configuration. In other words, the UE 1302 may use different SRS resources randomly for transmitting SRSs instead of using the same SRS resources for transmitting SRSs.

As described in connection with FIGS. 10 and 11, the second cell or the second set of cells may be cell(s) that are farther away from the UE 1302 or cell(s) predicted by the network entity 1304 to be less likely accessed by the UE 1302 compared to the first cell or the first set of cells. Thus, as there is a lower likelihood for the UE 1302 to move to the second cell or the second set of cells, the UE 1302 may have more “randomness” configured for the second cell or the second set of cells to prevent over-budgeting of SRS resources. Similarly, as described in connection with FIG. 11, the network entity 1304 may consider previous recorded/collected mobility patterns to determine the likelihood of the UE 1302 pre-configured with area-specific SRS appear on cells/areas farther away from the initial cell. This information may be received by the LMF, or by a corresponding network entity (e.g., an NWDAF).

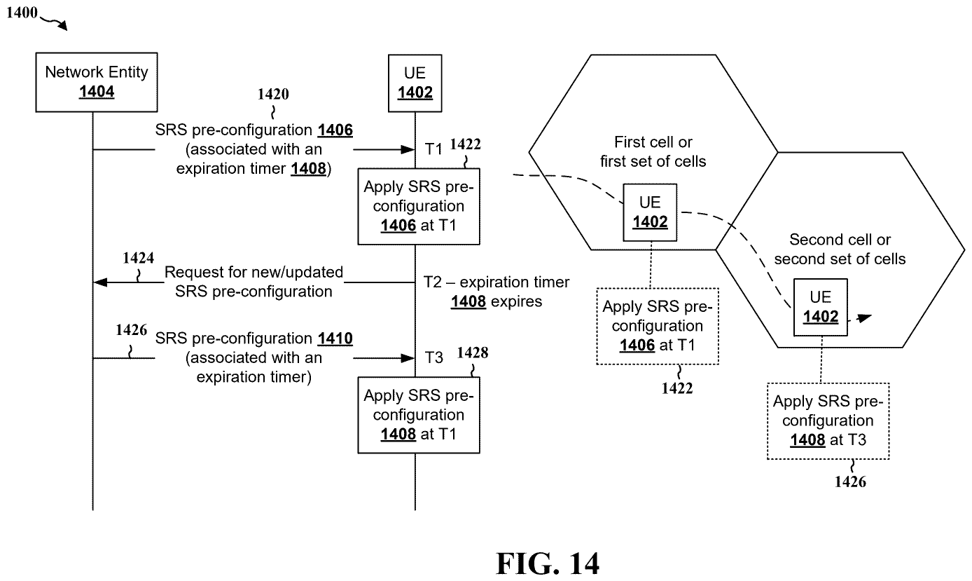

FIG. 14 is a diagram 1400 illustrating an example of associating an expiration timer for each SRS pre-configuration in accordance with various aspects of the present disclosure. In another aspect of the present disclosure, in addition to the expiration timer that is used for time alignment (e.g., the inactivePosSRS-TimeAlignmentTimer parameter shown by FIG. 6), an expiration timer may also assign to an SRS pre-configuration itself. This means, if a UE receives/applies an SRS pre-configuration at a first point in time (e.g., T1) and the UE starts to move around, after a second point in time (T2) (e.g., after the timer for the SRS pre-configuration applied at T1 expires), the UE may be specified to request a new/updated SRS pre-configuration from the network.

For example, as shown at 1420, a network entity 1404 (e.g., a base station, a location server, an LMF, etc.) may pre-configure a UE 1402 with an SRS pre-configuration 1406 which the UE 1402 may apply when the UE 1402 camps on a first cell or on one cell of a first set of cells, or on a second cell or on one cell of a second set of cells, etc. In addition, the SRS pre-configuration 1406 may be associated with an expiration timer 1408. As shown at 1422, after the UE 1402 receives the SRS pre-configuration 1406, the UE 1402 may apply the SRS pre-configuration 1406 at a first point in time (e.g., at T1).

As shown at 1424, after the expiration timer 1408 expires, the UE 1402 may be prevented from continuing using the SRS pre-configuration 1406, and the UE 1402 may request a new/updated SRS pre-configuration from the network entity 1404. As shown at 1426, in response to the request from the UE 1402, the network entity 1404 may transmit a new/updated SRS pre-configuration 1410 to the UE 1402 which the UE 1402 may apply when the UE 1402 camps on the first cell or on one cell of the first set of cells, on the second cell or on one cell of the second set of cells, and/or on additional new cell(s) or new set of cells, etc.

As shown at 1428, after the UE 1402 receives the new/updated SRS pre-configuration 1410, the UE 1402 may apply the SRS pre-configuration 1410 at a third point in time (e.g., at T3). The new/updated SRS pre-configuration 1410 may also be associated with an expiration timer, which may be the same or different from the expiration timer 1408 depending on the implementation.

In one example, the UE 1402 may be configured to indicate information related to the SRS pre-configuration it is currently using to the network entity 1404 (e.g., the SRS pre-configuration 1406), such as the time, the date, and/or the ID associated with the SRS pre-configuration. Then, the network entity 1404 may determine whether the SRS pre-configuration or the SRS pre-configuration database currently used by the UE 1402 is valid or not.

For example, referring back to FIG. 8, at step 3, a UE (e.g., the 1402) may indicate information related to the SRS pre-configuration it is currently using to a network entity (e.g., a base station, the network entity 1404) in an RRC resume request and/or in an SRS activation request, etc. Then, in step 5 or step 8, the network entity may inform the UE of the existence of a new SRS pre-configuration (e.g., the SRS pre-configuration 1406) and that the UE may no longer use the previous SRS pre-configuration (e.g., the SRS pre-configuration 1406). For example, the message may instruct the UE to “append” to the current SRS pre-configuration, or “reset,” or “remove” some entries and add new entries associated with the current SRS pre-configuration.

In some examples, referring back to FIG. 14, the expiration timer 1408 may be area-specific and/or cell-specific, or it may be a total configuration across multiple or all areas. In addition, the message of instructing about appending/resetting/removing entries, may also be area-specific or cell-specific. In some implementations, an interference metric (e.g., an SRS busy ratio) that tracks how busy each SRS pre-configuration is may be defined and reported by a base station/TRP that receives the SRS from the UE 1402, such as the percentage of the instances in an SRS measurement window in which a specific SRS resource has been measured to be occupied. Then, based on the interference metric, the location server (e.g., an LMF) may adjust parameters for the SRS pre-configuration to reduce the interference.

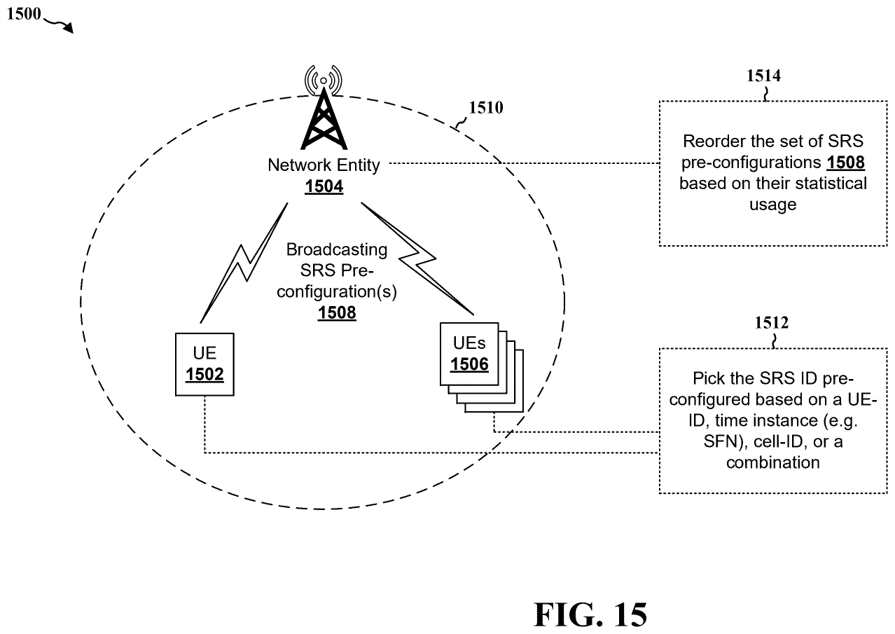

FIG. 15 is a diagram 1500 illustrating an example of a network entity broadcasting SRS pre-configurations in accordance with various aspects of the present disclosure. In another aspect of the present disclosure, if a network entity is configured to broadcast SRS pre-configurations, such as via positioning system information blocks (posSIBs), a UE that receive the broadcasted SRS pre-configurations may be specified to apply certain rules in selecting which SRS pre-configuration(s) to apply. For example, as shown at 1510, a network entity 1504 (e.g., a base station/TRP, a location server, an LMF, etc.) may be configured to broadcast a set of SRS pre-configurations 1508, such as via a posSIB, where the set of broadcasted SRS pre-configurations 1508 may be received by a plurality of UEs, which may include a UE 1502 and one or more UEs 1506, etc.

In one example, to enable different SRS pre-configurations in the set of SRS pre-configurations 1508 are being applied by the receiving UEs evenly (or as evenly as possible), UEs may be configured to select an SRS pre-configuration from the set of SRS pre-configurations 1508 randomly, based on certain pattern(s), and/or based on certain predefined rules. For example, as shown at 1512, the UE 1502 and the one or more UEs 1506 may be configured to select an SRS pre-configuration or its corresponding SRS pre-configuration ID based on their UE-ID, time instance (e.g., system frame number (SFN)), cell-ID, or a combination of. As an illustration, the UE 1502 with a UE-ID X may be configured to pick an SRS pre-configuration (or a corresponding SRS pre-configuration ID) associated with a currently camped cell that is equal to the last Y digits of the UE-ID. As an alternative, the UE 1502 may be configured to randomly pick one SRS pre-configuration in the set of SRS pre-configurations 1508 associated with the currently camped cell.

In another example, as shown at 1514, to enable different SRS pre-configurations in the set of SRS pre-configurations 1508 are being applied by the receiving UEs evenly, the network entity 1504 may reorder the set of SRS pre-configurations 1508 based on their statistical usage. For example, in an SRS pre-configuration broadcast message (e.g., in the posSIB), the network entity 1504 may perform reordering of the set of SRS pre-configurations 1508 that are being busy, or have been busy in the past. As an illustration, the network entity 1504 may initially broadcast the set of SRS pre-configurations 1508 with each SRS pre-configuration in the set of SRS pre-configurations 1508 being associated with a priority (e.g., level 1 to X), and a UE receiving the set of SRS pre-configurations 1508 may be configured to apply the SRS pre-configuration(s) based on their associated priorities. Then, if the network entity 1504 detects that certain SRS pre-configurations are being applied more often than others, the network entity 1504 may change their associated priorities. For example, SRS pre-configurations that are being applied more frequently (e.g., over a defined period of time or over last X minutes, etc.) may be re-assigned with a lower priority, whereas SRS pre-configurations that are being applied more frequently may be re-assigned with a higher priority in comparison. In another example, instead of associating SRS pre-configurations with priorities, the network entity 1504 may broadcast busy SRS pre-configurations (e.g., SRS pre-configurations that are being applied more frequently) less often, such as with a longer periodicity, and broadcast non-busy SRS pre-configurations (e.g., SRS pre-configurations that are being applied less frequently) more often, such as with a shorter periodicity.

In one aspect, to determine whether certain SRS pre-configuration(s) have been applied more frequently, the network entity 1504 may consider previous recorded/collected SRS collision and/or SRS assignment patterns to determine such information. This information may also be received by the LMF (e.g., transmitted from a base station/TRP), or by a corresponding network entity (e.g., the 5G NWDAF).

In another aspect of the present disclosure, a location server (e.g., an LMF) may indicate to a network node (e.g., a base station, a gNB, etc.) specific properties associated with SRS pre-configurations, where the network node may be configured to follow these specific properties in pre-configuring the SRS pre-configurations. For example, referring back to FIG. 8, as shown at 804, in a pre-configured SRS request message (e.g., using the NRPPa positioning information request message), an LMF may include information associated with pre-configuring SRS pre-configurations with specific properties, which may include:
(1) an interference threshold for SRS interference (e.g., busy ratio is specified to be smaller than a busy ratio threshold),
(2) a number of cells or areas to be pre-configured for the UE,
(3) an indication of whether to pre-configure a first-tier of neighboring cells or a second-tier of neighboring cells for the UE,
(4) a distance of cells or areas from a serving cell to be pre-configured for the UE,
(5) an indication of whether to pre-configure pathloss (PL) for the UE (and/or whether to include PL pre-configuration in the pre-configured SRS configurations response message at 806),
(6) an indication of whether to pre-configure a spatial relation for the UE (and/or whether to include spatial relation pre-configuration in the pre-configured SRS configurations response message at 806) (this may correspond to a reference signal that the UE is expected to measure in order to derive the Tx transmit beam, which may be an SSB, a PRS, and/or other DL reference signal(s), etc., or it may also be another SRS signal in which case, it means that the UE may use the same Tx beam as the SRS signal using as spatial relation reference),
(7) an indication of whether to pre-configure a timing advance (TA) alignment for the UE (and/or whether to include TA alignment pre-configuration in the pre-configured SRS configurations response message at 806) (a TA timer may be a value that indicates for how long a UE is to keep a TA value valid),
(8) an indication of whether to pre-configure a reference signal received power (RSRP)-change threshold for the UE (and/or whether to include RSRP-change threshold pre-configuration in the pre-configured SRS configurations response message at 806), or
(9) a combination thereof.

Aspects described in connection with FIGS. 5 to 15 may improve SRS resource utilizations/allocations, and prevent over-budgeting of SRS resources. SRS (pre-) configurations may be provided to a UE as part of LPP request or a positioning SIB may broadcast a pre-configured SRS with multiple configurations where each configuration may be applicable to a different area within the network. A UE may use the SRS configuration within an AREA validity of AREA ID (which may include one or more cells). In one aspect, in the pre-configuration of SRS, gNB/network may assign to a UE that is initially camped to cell 1 an SRS-resource1 and an SRS-resource2 to be used in the UE camps on cell2, where the SRS-resource2 may have a reduced overhead relative to SRS-resource1. In another aspect, the SRS-resource1 is orthogonal with the remaining UEs at that time in that cell, but the gNB/network assigns an SRS-resoruce2 to be used if the UE camps on cell2, where the SRS-resource2 is not orthogonal with the SRS active to the cell2. In another aspect, in the pre-configuration of the SRS, gNB may assign a UE with multiple configurations associated with cell2. In a further aspect, in addition to the expiration timer that is used for time alignment, another expiration timer for the SRS pre-configuration is proposed.

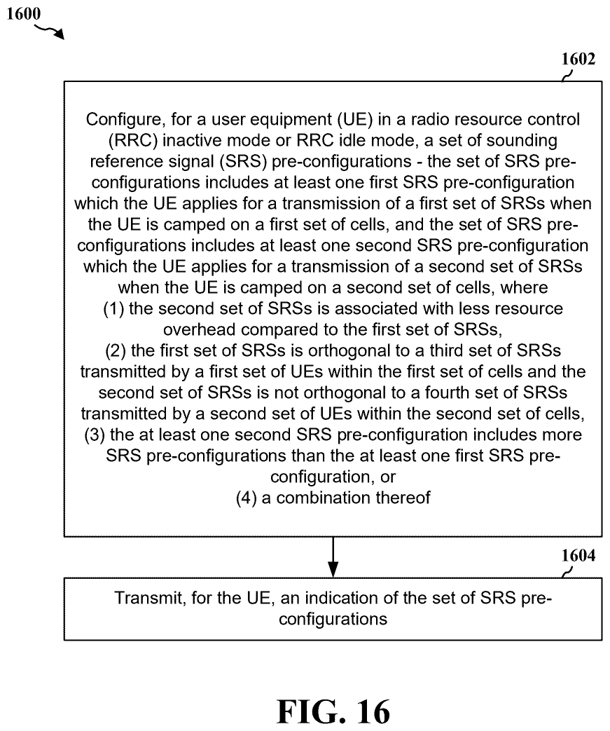

FIG. 16 is a flowchart 1600 of a method of wireless communication. The method may be performed by a network entity (e.g., the base station 102; the network entity 1004, 1104, 1204, 1304, 1404, 1504, 1802). The method may enable the network entity to avoid over-budgeting SRS resources when the network entity is pre-configuring a plurality of UEs with SRS (pre-) configurations, such as UEs that are within the same cell or in neighbouring cells.

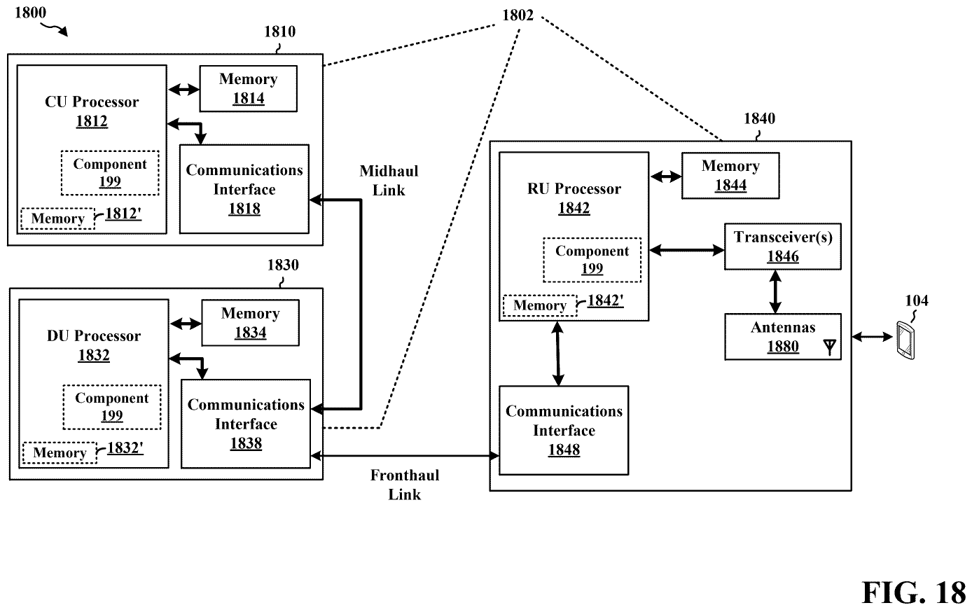

At 1602, the network entity may configure, for a UE in an RRC inactive mode or RRC idle mode, a set of SRS pre-configurations, where the set of SRS pre-configurations includes at least one first SRS pre-configuration which the UE applies for a transmission of a first set of SRSs when the UE is camped on a first set of cells, and the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRSs, (2) the first set of SRSs is orthogonal to transmit, to the first network entity, information indicative of the set of SRS pre-configurations—the information includes at least one of: a time of each SRS pre-configuration in the set of SRS pre-configurations, a date of each SRS pre-configuration in the set of SRS pre-configurations, an ID of each SRS pre-configuration in the set of SRS pre-configurations a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof, such as described in connection with FIGS. 10-15. For example, as shown at 1010 of FIG. 10, the network entity 1004 (e.g., a base station, an LMF, etc.) may pre-configure the UE 1002 that is initially camped on Cell 4 with more SRS resources for Cell 4 compared to cells that are farther away (e.g., Cell 9, Cell N, etc.). The configuration of the set of SRS pre-configurations may be performed by, e.g., the SRS pre-configuration component 199, the RU processor 1842, and/or the transceiver(s) 1846 of the network entity 1802 in FIG. 18.

At 1604, the network entity may transmit, for the UE, an indication of the set of SRS pre-configurations, such as described in connection with FIGS. 10-15. For example, as shown in FIG. 10, the network entity 1004 may transmit SRS pre-configurations to the UE 1002. The transmission of the indication of the set of SRS pre-configurations may be performed by, e.g., the SRS pre-configuration component 199, the RU processor 1842, and/or the transceiver(s) 1846 of the network entity 1802 in FIG. 18.

In one example, each SRS pre-configuration in the set of SRS pre-configurations is associated with an expiration timer.

In another example, the network entity may receive, from the UE, a request for one or more new or updated SRS-reconfigurations after an expiration of the expiration timer for one or more SRS pre-configurations in the set of SRS pre-configurations, such as described in connection with FIG. 14. For example, at 1424, after the expiration timer 1408 expires, the network entity 1404 may receive a request from the UE 1402 for a new/updated SRS pre-configuration. The reception of the request for one or more new or updated SRS-reconfigurations may be performed by, e.g., the SRS pre-configuration component 199, the RU processor 1842, and/or the transceiver(s) 1846 of the network entity 1802 in FIG. 18.

In another example, the resource overhead may correspond to an SRS periodicity, a number of symbols for an SRS, a bandwidth, or a combination thereof.

In another example, the second set of cells may be farther away from the UE compared to the first set of cells or the second set of cells may have a lower probability on which to be camped by the UE compared to the first set of cells.

In another example, the first set of cells may include an initial cell on which the UE is camped and one or more neighbour cells that are adjacent to the initial cell.

In another example, to transmit the set of SRS pre-configurations, the network entity may broadcast the set of SRS pre-configurations to a plurality of UEs including the UE. In some implementations, each SRS pre-configuration in the set of SRS pre-configurations may be associated with an SRS configuration ID. In some implementations, the network entity may order or prioritize one or more SRS pre-configurations in the set of SRS pre-configurations based on at least one condition associated with the one or more SRS pre-configurations. In some implementations, the at least one condition may include: whether the one or more SRS pre-configurations have a high usage, whether the one or more SRS pre-configurations have a collision history, whether the one or more SRS pre-configurations are causing interference, or a combination thereof.

In another example, the network entity is an LMF, the network entity may transmit, for a second network entity, a request to generate the set of SRS pre-configurations for the UE according to a set of criteria; and receive, from the second network entity, the set of SRS pre-configurations for the UE that meets the set of criteria. In some implementations, the set of criteria may include: an interference threshold for SRS interference, a number of cells or areas to be pre-configured for the UE, a first indication of whether to pre-configure a first-tier of neighbouring cells or a second-tier of neighbouring cells for the UE, a distance of cells or areas from a serving cell to be pre-configured for the UE, a second indication of whether to pre-configure PL for the UE, a third indication of whether to pre-configure a beam spatial relation for the UE, a fourth indication of whether to pre-configure a TA timer for the UE, a fifth indication of whether to pre-configure an RSRP-change threshold for the UE, or a combination thereof.

In another example, the network entity may identify at least one first cell of the first set of cells or at least one second cell of the second set of cells based on one or more previous mobility patterns of the UE, such as described in connection with FIGS. 10-15. For example, as shown at 1112 of FIG. 11, the network entity 1104 (e.g., a base station, an LMF, etc.) may pre-configure the UE 1102 with different SRS resources for different cells based on the mobility pattern of the UE 1102. The identification of the at least one first cell of the first set of cells or at least one second cell of the second set of cells based on one or more previous mobility patterns of the UE may be performed by, e.g., the SRS pre-configuration component 199, the RU processor 1842, and/or the transceiver(s) 1846 of the network entity 1802 in FIG. 18.

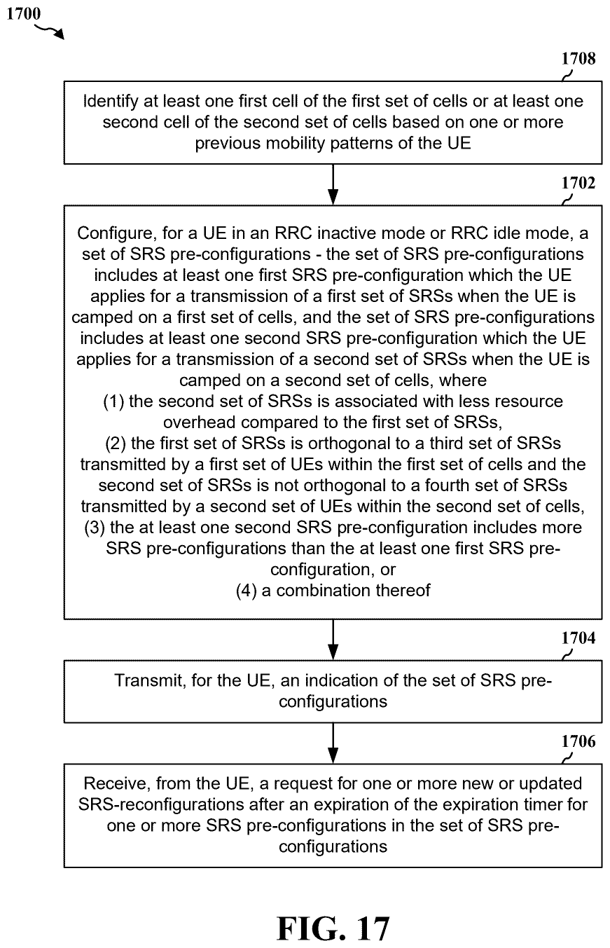

FIG. 17 is a flowchart 1700 of a method of wireless communication. The method may be performed by a network entity (e.g., the base station 102; the network entity 1004, 1104, 1204, 1304, 1404, 1504, 1802). The method may enable the network entity to avoid over-budgeting SRS resources when the network entity is pre-configuring a plurality of UEs with SRS (pre-) configurations, such as UEs that are within the same cell or in neighbouring cells.

At 1702, the network entity may configure, for a UE in an RRC inactive mode or RRC idle mode, a set of SRS pre-configurations, where the set of SRS pre-configurations includes at least one first SRS pre-configuration which the UE applies for a transmission of a first set of SRSs when the UE is camped on a first set of cells, and the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof, such as described in connection with FIGS. 10-15. For example, as shown at 1010 of FIG. 10, the network entity 1004 (e.g., a base station, an LMF, etc.) may pre-configure the UE 1002 that is initially camped on Cell 4 with more SRS resources for Cell 4 compared to cells that are farther away (e.g., Cell 9, Cell N, etc.). The configuration of the set of SRS pre-configurations may be performed by, e.g., the SRS pre-configuration component 199, the RU processor 1842, and/or the transceiver(s) 1846 of the network entity 1802 in FIG. 18.

At 1704, the network entity may Transmit, for the UE, an indication of the set of SRS pre-configurations, such as described in connection with FIGS. 10-15. For example, as shown in FIG. 10, the network entity 1004 may transmit SRS pre-configurations to the UE 1002. The transmission of the indication of the set of SRS pre-configurations may be performed by, e.g., the SRS pre-configuration component 199, the RU processor 1842, and/or the transceiver(s) 1846 of the network entity 1802 in FIG. 18.

In one example, each SRS pre-configuration in the set of SRS pre-configurations is associated with an expiration timer.

In another example, at 1706, the network entity may receive, from the UE, a request for one or more new or updated SRS-reconfigurations after an expiration of the expiration timer for one or more SRS pre-configurations in the set of SRS pre-configurations, such as described in connection with FIG. 14. For example, at 1424, after the expiration timer 1408 expires, the network entity 1404 may receive a request from the UE 1402 for a new/updated SRS pre-configuration. The reception of the request for one or more new or updated SRS-reconfigurations may be performed by, e.g., the SRS pre-configuration component 199, the RU processor 1842, and/or the transceiver(s) 1846 of the network entity 1802 in FIG. 18.

In another example, the resource overhead may correspond to an SRS periodicity, a number of symbols for an SRS, a bandwidth, or a combination thereof.

In another example, the second set of cells may be farther away from the UE compared to the first set of cells or the second set of cells may have a lower probability on which to be camped by the UE compared to the first set of cells.

In another example, the first set of cells may include an initial cell on which the UE is camped and one or more neighbour cells that are adjacent to the initial cell.

In another example, to transmit the set of SRS pre-configurations, the network entity may broadcast the set of SRS pre-configurations to a plurality of UEs including the UE. In some implementations, each SRS pre-configuration in the set of SRS pre-configurations may be associated with an SRS configuration ID. In some implementations, the network entity may order or prioritize one or more SRS pre-configurations in the set of SRS pre-configurations based on at least one condition associated with the one or more SRS pre-configurations. In some implementations, the at least one condition may include: whether the one or more SRS pre-configurations have a high usage, whether the one or more SRS pre-configurations have a collision history, whether the one or more SRS pre-configurations are causing interference, or a combination thereof.

In another example, the network entity is an LMF, the network entity may transmit, for a second network entity, a request to generate the set of SRS pre-configurations for the UE according to a set of criteria; and receive, from the second network entity, the set of SRS pre-configurations for the UE that meets the set of criteria. In some implementations, the set of criteria may include: an interference threshold for SRS interference, a number of cells or areas to be pre-configured for the UE, a first indication of whether to pre-configure a first-tier of neighbouring cells or a second-tier of neighbouring cells for the UE, a distance of cells or areas from a serving cell to be pre-configured for the UE, a second indication of whether to pre-configure PL for the UE, a third indication of whether to pre-configure a beam spatial relation for the UE, a fourth indication of whether to pre-configure a TA timer for the UE, a fifth indication of whether to pre-configure an RSRP-change threshold for the UE, or a combination thereof.

In another example, at 1708, the network entity may identify at least one first cell of the first set of cells or at least one second cell of the second set of cells based on one or more previous mobility patterns of the UE, such as described in connection with FIGS. 10-15. For example, as shown at 1112 of FIG. 11, the network entity 1104 (e.g., a base station, an LMF, etc.) may pre-configure the UE 1102 with different SRS resources for different cells based on the mobility pattern of the UE 1102. The identification of the at least one first cell of the first set of cells or at least one second cell of the second set of cells based on one or more previous mobility patterns of the UE may be performed by, e.g., the SRS pre-configuration component 199, the RU processor 1842, and/or the transceiver(s) 1846 of the network entity 1802 in FIG. 18.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the SRS pre-configuration component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the SRS pre-configuration component 199 may be configured to configure, for a UE in an RRC inactive mode or RRC idle mode, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof. The SRS pre-configuration component 199 may also be configured to transmit, for the UE, an indication of the set of SRS pre-configurations. The SRS pre-configuration component 199 may be within one or more processors of one or more of the CU 1810, DU 1830, and the RU 1840. The SRS pre-configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for configuring, for a UE in an RRC inactive mode or RRC idle mode, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof. The network entity 1802 may further include means for transmitting, for the UE, an indication of the set of SRS pre-configurations.

In one configuration, each SRS pre-configuration in the set of SRS pre-configurations is associated with an expiration timer.

In another configuration, the network entity 1802 may further include means for receiving, from the UE, a request for one or more new or updated SRS-reconfigurations after an expiration of the expiration timer for one or more SRS pre-configurations in the set of SRS pre-configurations.

In another configuration, the resource overhead may correspond to an SRS periodicity, a number of symbols for an SRS, a bandwidth, or a combination thereof.

In another configuration, the second set of cells may be farther away from the UE compared to the first set of cells or the second set of cells may have a lower probability on which to be camped by the UE compared to the first set of cells.

In another configuration, the first set of cells may include an initial cell on which the UE is camped and one or more neighbour cells that are adjacent to the initial cell.

In another configuration, the means for transmitting the set of SRS pre-configurations may include configuring the network entity 1802 to broadcast the set of SRS pre-configurations to a plurality of UEs including the UE. In some implementations, each SRS pre-configuration in the set of SRS pre-configurations may be associated with an SRS configuration ID. In some implementations, the network entity 1802 may further include means for ordering or prioritizing one or more SRS pre-configurations in the set of SRS pre-configurations based on at least one condition associated with the one or more SRS pre-configurations. In some implementations, the at least one condition may include: whether the one or more SRS pre-configurations have a high usage, whether the one or more SRS pre-configurations have a collision history, whether the one or more SRS pre-configurations are causing interference, or a combination thereof.

In another configuration, the network entity is an LMF, the network entity 1802 may further include means for transmitting, for a second network entity, a request to generate the set of SRS pre-configurations for the UE according to a set of criteria; and means for receiving, from the second network entity, the set of SRS pre-configurations for the UE that meets the set of criteria. In some implementations, the set of criteria may include: an interference threshold for SRS interference, a number of cells or areas to be pre-configured for the UE, a first indication of whether to pre-configure a first-tier of neighbouring cells or a second-tier of neighbouring cells for the UE, a distance of cells or areas from a serving cell to be pre-configured for the UE, a second indication of whether to pre-configure PL for the UE, a third indication of whether to pre-configure a beam spatial relation for the UE, a fourth indication of whether to pre-configure a TA timer for the UE, a fifth indication of whether to pre-configure an RSRP-change threshold for the UE, or a combination thereof.

In another configuration, the network entity 1802 may further include means for identifying at least one first cell of the first set of cells or at least one second cell of the second set of cells based on one or more previous mobility patterns of the UE.

The means may be the SRS pre-configuration component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

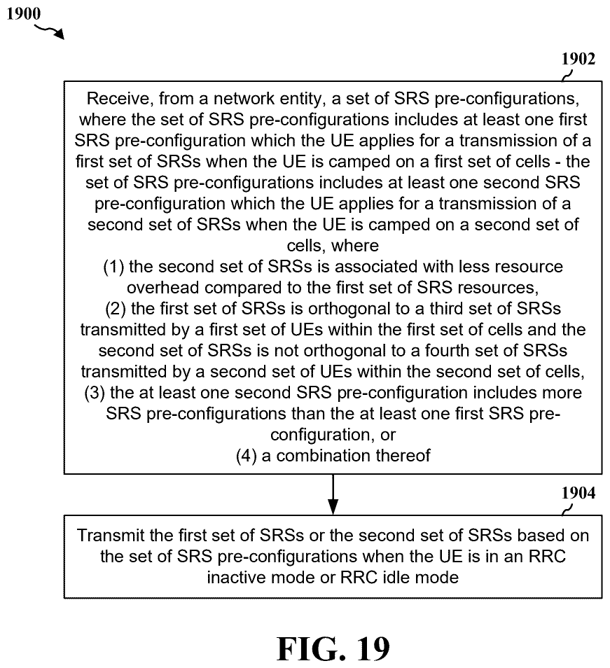

FIG. 19 is a flowchart 1900 of a method of wireless communication. The method may be performed by a UE (e.g., the UE 104, 404, 1002, 1102, 1202, 1302, 1402, 1502; the apparatus 2104). The method may enable the UE to receive SRS (pre-) configurations and apply SRS (pre-) configurations in a specific way to improve SRS resource budgeting.

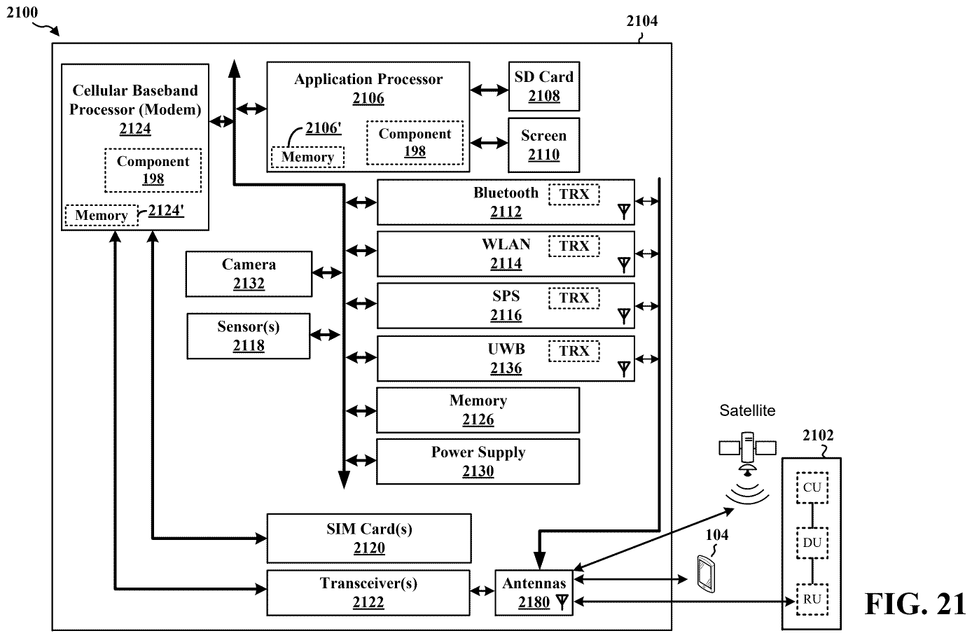

At 1902, the UE may receive, from a network entity, a set of SRS pre-configurations, where the set of SRS pre-configurations includes at least one first SRS pre-configuration which the UE applies for a transmission of a first set of SRSs when the UE is camped on a first set of cells, where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof, such as described in connection with FIGS. 10 to 15. For example, as shown at 1010 of FIG. 10, the UE 1002 may receive SRS pre-configurations from the network entity 1004 (e.g., a base station, an LMF, etc.), where more SRS resources are configured for cells in which the UE 1002 is camped on (e.g., Cell 4) compared to cells that are farther away from the UE (e.g., Cell 9, Cell N, etc.). The reception of the set of SRS pre-configurations may be performed by, e.g., the SRS pre-configuration processing component 198, the application processor 2106, the cellular baseband processor 2124, and/or the transceiver(s) 2122 of the apparatus 2104 in FIG. 21.

In one example, the resource overhead may correspond to an SRS periodicity, a number of symbols for an SRS, a bandwidth, or a combination thereof.

In another example, the second set of cells may be farther away from the UE compared to the first set of cells or the second set of cells may have a lower probability on which to be camped by the UE compared to the first set of cells.

In another example, the first set of cells may include an initial cell on which the UE is camped and one or more neighbour cells that are adjacent to the initial cell.

In another example, to transmit the second set of SRSs based on the set of SRS pre-configurations, the UE may select, randomly or based on a pattern, one SRS pre-configuration from the at least one second SRS pre-configuration; and transmit the second set of SRSs based on the selected one SRS pre-configuration.

In another example, each SRS pre-configuration in the set of SRS pre-configurations is associated with an SRS configuration ID. In some implementations, the UE may select the at least one first SRS pre-configuration or the at least one second SRS pre-configuration from the set of SRS pre-configurations based on the SRS configuration ID being associated with the at least one first SRS pre-configuration or the at least one second SRS pre-configuration.

At 1904, the UE may transmit the first set of SRSs or the second set of SRSs based on the set of SRS pre-configurations when the UE is in an RRC inactive mode or RRC idle mode, such as described in connection with FIGS. 5 and 10 to 15. For example, as shown by FIG. 5, when the UE 502 is within the area associated with the first area ID, the UE 502 may apply an SRS configuration that corresponds to the first area ID, such as transmitting a set of SRSs to TRP(s) #1, 2, and/or 3 using specified time resources, frequency resources, periodicity, bandwidth, etc. The transmission of the first set of SRSs or the second set of SRSs may be performed by, e.g., the SRS pre-configuration processing component 198, the application processor 2106, the cellular baseband processor 2124, and/or the transceiver(s) 2122 of the apparatus 2104 in FIG. 21.

In one example, each SRS pre-configuration in the set of SRS pre-configurations may be associated with an expiration timer.

In another example, the UE may transmit, to the first network entity, a request for one or more new or updated SRS-reconfigurations after an expiration of the expiration timer for one or more SRS pre-configurations in the set of SRS pre-configurations, such as described in connection with FIG. 14. For example, at 1424, after the expiration timer 1408 expires, the UE 1402 may be prevented from continuing using the SRS pre-configuration 1406, and the UE 1402 may request a new/updated SRS pre-configuration from the network entity 1404. The transmission of the request for one or more new or updated SRS-reconfigurations may be performed by, e.g., the SRS pre-configuration processing component 198, the application processor 2106, the cellular baseband processor 2124, and/or the transceiver(s) 2122 of the apparatus 2104 in FIG. 21.

In another example, the UE may transmit, to the first network entity, information indicative of the set of SRS pre-configurations, where the information includes at least one of: a time of each SRS pre-configuration in the set of SRS pre-configurations, a date of each SRS pre-configuration in the set of SRS pre-configurations, an ID of each SRS pre-configuration in the set of SRS pre-configurations, such as described in connection with FIG. 14. For example, the UE 1402 may be configured to indicate information related to the SRS pre-configuration it is currently using to the network entity 1404 (e.g., the SRS pre-configuration 1406), such as the time, the date, and/or the ID associated with the SRS pre-configuration. Then, the network entity 1404 may determine whether the SRS pre-configuration or the SRS pre-configuration database currently used by the UE 1402 is valid or not. The transmission of the information indicative of the set of SRS pre-configurations may be performed by, e.g., the SRS pre-configuration processing component 198, the application processor 2106, the cellular baseband processor 2124, and/or the transceiver(s) 2122 of the apparatus 2104 in FIG. 21.

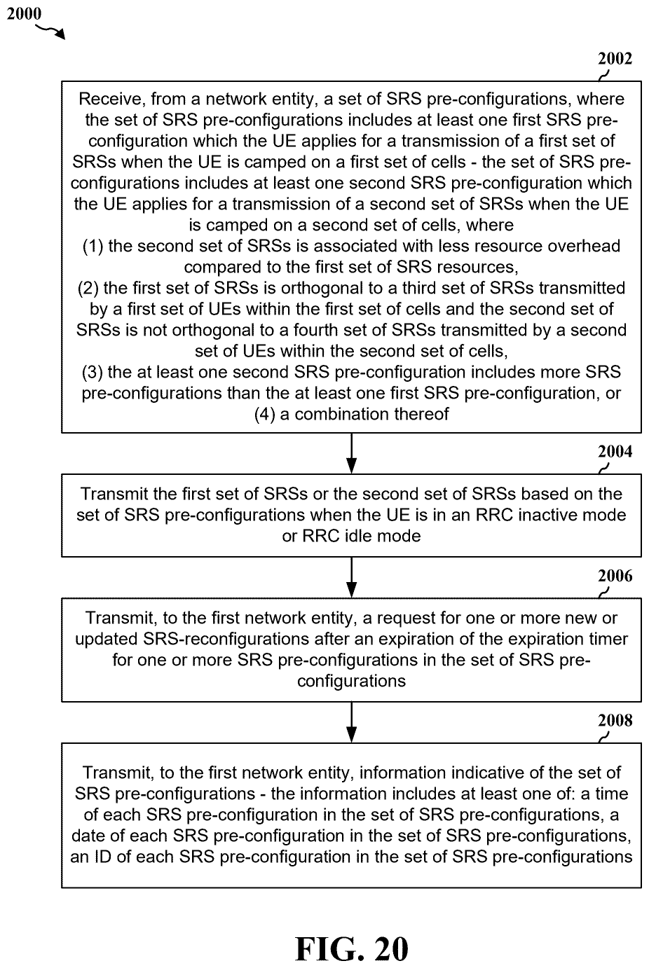

FIG. 20 is a flowchart 2000 of a method of wireless communication. The method may be performed by a UE (e.g., the UE 104, 404, 1002, 1102, 1202, 1302, 1402, 1502; the apparatus 2104). The method may enable the UE to receive SRS (pre-) configurations and apply SRS (pre-) configurations in a specific way to improve SRS resource budgeting.

At 2002, the UE may receive, from a network entity, a set of SRS pre-configurations, where the set of SRS pre-configurations includes at least one first SRS pre-configuration which the UE applies for a transmission of a first set of SRSs when the UE is camped on a first set of cells, where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof, such as described in connection with FIGS. 10 to 15. For example, as shown at 1010 of FIG. 10, the UE 1002 may receive SRS pre-configurations from the network entity 1004 (e.g., a base station, an LMF, etc.), where more SRS resources are configured for cells in which the UE 1002 is camped on (e.g., Cell 4) compared to cells that are farther away from the UE (e.g., Cell 9, Cell N, etc.). The reception of the set of SRS pre-configurations may be performed by, e.g., the SRS pre-configuration processing component 198, the application processor 2106, the cellular baseband processor 2124, and/or the transceiver(s) 2122 of the apparatus 2104 in FIG. 21.

In one example, the resource overhead may correspond to an SRS periodicity, a number of symbols for an SRS, a bandwidth, or a combination thereof.

In another example, the second set of cells may be farther away from the UE compared to the first set of cells or the second set of cells may have a lower probability on which to be camped by the UE compared to the first set of cells.

In another example, the first set of cells may include an initial cell on which the UE is camped and one or more neighbour cells that are adjacent to the initial cell.

In another example, to transmit the second set of SRSs based on the set of SRS pre-configurations, the UE may select, randomly or based on a pattern, one SRS pre-configuration from the at least one second SRS pre-configuration; and transmit the second set of SRSs based on the selected one SRS pre-configuration.

In another example, each SRS pre-configuration in the set of SRS pre-configurations is associated with an SRS configuration ID. In some implementations, the UE may select the at least one first SRS pre-configuration or the at least one second SRS pre-configuration from the set of SRS pre-configurations based on the SRS configuration ID being associated with the at least one first SRS pre-configuration or the at least one second SRS pre-configuration.

At 2004, the UE may transmit the first set of SRSs or the second set of SRSs based on the set of SRS pre-configurations when the UE is in an RRC inactive mode or RRC idle mode, such as described in connection with FIGS. 5 and 10 to 15. For example, as shown by FIG. 5, when the UE 502 is within the area associated with the first area ID, the UE 502 may apply an SRS configuration that corresponds to the first area ID, such as transmitting a set of SRSs to TRP(s) #1, 2, and/or 3 using specified time resources, frequency resources, periodicity, bandwidth, etc. The transmission of the first set of SRSs or the second set of SRSs may be performed by, e.g., the SRS pre-configuration processing component 198, the application processor 2106, the cellular baseband processor 2124, and/or the transceiver(s) 2122 of the apparatus 2104 in FIG. 21.

In one example, each SRS pre-configuration in the set of SRS pre-configurations may be associated with an expiration timer.

In another example, at 2006, the UE may transmit, to the first network entity, a request for one or more new or updated SRS-reconfigurations after an expiration of the expiration timer for one or more SRS pre-configurations in the set of SRS pre-configurations, such as described in connection with FIG. 14. For example, at 1424, after the expiration timer 1408 expires, the UE 1402 may be prevented from continuing using the SRS pre-configuration 1406, and the UE 1402 may request a new/updated SRS pre-configuration from the network entity 1404. The transmission of the request for one or more new or updated SRS-reconfigurations may be performed by, e.g., the SRS pre-configuration processing component 198, the application processor 2106, the cellular baseband processor 2124, and/or the transceiver(s) 2122 of the apparatus 2104 in FIG. 21.

In another example, at 2008, the UE may transmit, to the first network entity, information indicative of the set of SRS pre-configurations, where the information includes at least one of: a time of each SRS pre-configuration in the set of SRS pre-configurations, a date of each SRS pre-configuration in the set of SRS pre-configurations, an ID of each SRS pre-configuration in the set of SRS pre-configurations, such as described in connection with FIG. 14. For example, the UE 1402 may be configured to indicate information related to the SRS pre-configuration it is currently using to the network entity 1404 (e.g., the SRS pre-configuration 1406), such as the time, the date, and/or the ID associated with the SRS pre-configuration. Then, the network entity 1404 may determine whether the SRS pre-configuration or the SRS pre-configuration database currently used by the UE 1402 is valid or not. The transmission of the information indicative of the set of SRS pre-configurations may be performed by, e.g., the SRS pre-configuration processing component 198, the application processor 2106, the cellular baseband processor 2124, and/or the transceiver(s) 2122 of the apparatus 2104 in FIG. 21.

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include a cellular baseband processor 2124 (also referred to as a modem) coupled to one or more transceivers 2122 (e.g., cellular RF transceiver). The cellular baseband processor 2124 may include on-chip memory 2124′. In some aspects, the apparatus 2104 may further include one or more subscriber identity modules (SIM) cards 2120 and an application processor 2106 coupled to a secure digital (SD) card 2108 and a screen 2110. The application processor 2106 may include on-chip memory 2106′. In some aspects, the apparatus 2104 may further include a Bluetooth® module 2112, a WLAN module 2114, an SPS module 2116 (e.g., GNSS module), an ultra-wideband (UWB) module 2136, one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth® module 2112, the WLAN module 2114, the UWB module 2136, and the SPS module 2116 may include an on-chip transceiver (TRX) (or in some cases, just a receiver (RX)). The Bluetooth® module 2112, the WLAN module 2114, the UWB module 2136, and the SPS module 2116 may include their own dedicated antennas and/or utilize the antennas 2180 for communication. The cellular baseband processor 2124 communicates through the transceiver(s) 2122 via one or more antennas 2180 with the UE 104 and/or with an RU associated with a network entity 2102. The cellular baseband processor 2124 and the application processor 2106 may each include a computer-readable medium/memory 2124′, 2106′, respectively. The additional memory modules 2126 may also be considered a computer-readable medium/memory. Each computer-readable medium/memory 2124′, 2106′, 2126 may be non-transitory. The cellular baseband processor 2124 and the application processor 2106 are each responsible for general processing, including the execution of software stored on the computer-readable medium/memory. The software, when executed by the cellular baseband processor 2124/application processor 2106, causes the cellular baseband processor 2124/application processor 2106 to perform the various functions described supra. The computer-readable medium/memory may also be used for storing data that is manipulated by the cellular baseband processor 2124/application processor 2106 when executing software. The cellular baseband processor 2124/application processor 2106 may be a component of the UE 350 and may include the memory 360 and/or at least one of the TX processor 368, the RX processor 356, and the controller/processor 359. In one configuration, the apparatus 2104 may be a processor chip (modem and/or application) and include just the cellular baseband processor 2124 and/or the application processor 2106, and in another configuration, the apparatus 2104 may be the entire UE (e.g., see UE 350 of FIG. 3) and include the additional modules of the apparatus 2104.

As discussed supra, the SRS pre-configuration processing component 198 may be configured to receive, from a network entity, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof. The SRS pre-configuration processing component 198 may also be configured to transmit the first set of SRSs or the second set of SRSs based on the set of SRS pre-configurations when the UE is in an RRC inactive mode or RRC idle mode. The SRS pre-configuration processing component 198 may be within the cellular baseband processor 2124, the application processor 2106, or both the cellular baseband processor 2124 and the application processor 2106. The SRS pre-configuration processing component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2104 may include a variety of components configured for various functions. In one configuration, the apparatus 2104, and in particular the cellular baseband processor 2124 and/or the application processor 2106, may include means for receiving, from a network entity, a set of SRS pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof. The apparatus 2104 may further include means for transmitting the first set of SRSs or the second set of SRSs based on the set of SRS pre-configurations when the UE is in an RRC inactive mode or RRC idle mode.

In one configuration, the resource overhead may correspond to an SRS periodicity, a number of symbols for an SRS, a bandwidth, or a combination thereof.

In another configuration, the second set of cells may be farther away from the UE compared to the first set of cells or the second set of cells may have a lower probability on which to be camped by the UE compared to the first set of cells.

In another configuration, the first set of cells may include an initial cell on which the UE is camped and one or more neighbour cells that are adjacent to the initial cell.

In another configuration, the means for transmitting the second set of SRSs based on the set of SRS pre-configurations may include configuring the apparatus 2104 to select, randomly or based on a pattern, one SRS pre-configuration from the at least one second SRS pre-configuration; and transmit the second set of SRSs based on the selected one SRS pre-configuration.

In another configuration, each SRS pre-configuration in the set of SRS pre-configurations is associated with an SRS configuration ID. In some implementations, the apparatus 2104 may further include means for selecting the at least one first SRS pre-configuration or the at least one second SRS pre-configuration from the set of SRS pre-configurations based on the SRS configuration ID being associated with the at least one first SRS pre-configuration or the at least one second SRS pre-configuration.

In another configuration, each SRS pre-configuration in the set of SRS pre-configurations may be associated with an expiration timer.

In another configuration, the apparatus 2104 may further include means for transmitting, to the first network entity, a request for one or more new or updated SRS-reconfigurations after an expiration of the expiration timer for one or more SRS pre-configurations in the set of SRS pre-configurations.

In another configuration, the apparatus 2104 may further include means for transmitting, to the first network entity, information indicative of the set of SRS pre-configurations, where the information includes at least one of: a time of each SRS pre-configuration in the set of SRS pre-configurations, a date of each SRS pre-configuration in the set of SRS pre-configurations, an ID of each SRS pre-configuration in the set of SRS pre-configurations.

The means may be the SRS pre-configuration processing component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

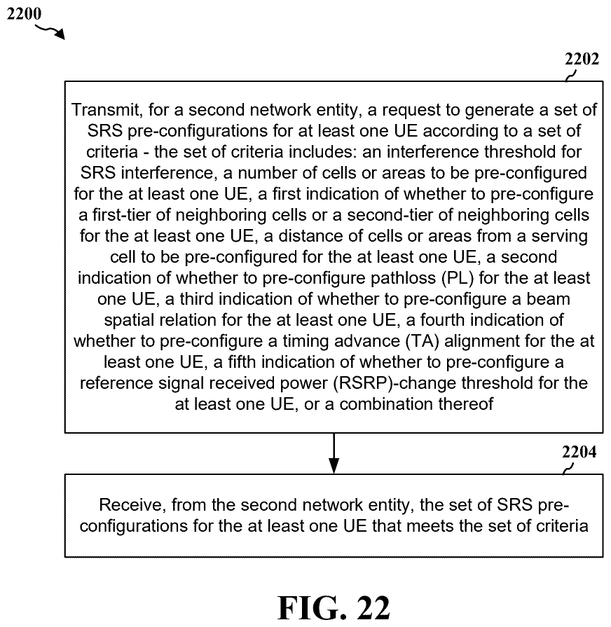

FIG. 22 is a flowchart 2200 of a method of wireless communication. The method may be performed by a first network entity (e.g., the one or more location servers 168; an LMF; the network entity 2360).

At 2202, the first network entity may transmit, for a second network entity, a request to generate a set of SRS pre-configurations for at least one UE according to a set of criteria, where the set of criteria includes: an interference threshold for SRS interference, a number of cells or areas to be pre-configured for the at least one UE, a first indication of whether to pre-configure a first-tier of neighboring cells or a second-tier of neighboring cells for the at least one UE, a distance of cells or areas from a serving cell to be pre-configured for the at least one UE, a second indication of whether to pre-configure PL for the at least one UE, a third indication of whether to pre-configure a beam spatial relation for the at least one UE, a fourth indication of whether to pre-configure a TA timer for the at least one UE, a fifth indication of whether to pre-configure an RSRP-change threshold for the at least one UE, or a combination thereof.

At 2204, the first network entity may receive, from the second network entity, the set of SRS pre-configurations for the at least one UE that meets the set of criteria.

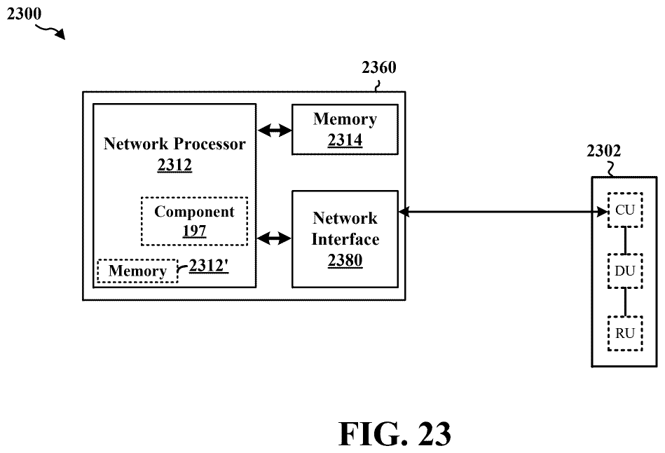

FIG. 23 is a diagram 2300 illustrating an example of a hardware implementation for a network entity 2360. In one example, the network entity 2360 may be within the core network 120. The network entity 2360 may include a network processor 2312. The network processor 2312 may include on-chip memory 2312′. In some aspects, the network entity 2360 may further include additional memory modules 2314. The network entity 2360 communicates via the network interface 2380 directly (e.g., backhaul link) or indirectly (e.g., through a RIC) with the CU 2302. The on-chip memory 2312′ and the additional memory modules 2314 may each be considered a computer-readable medium/memory. Each computer-readable medium/memory may be non-transitory. The processor 2312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the SRS pre-configuration request component 197 may be configured to transmit, for a second network entity, a request to generate a set of SRS pre-configurations for at least one UE according to a set of criteria, where the set of criteria includes: an interference threshold for SRS interference, a number of cells or areas to be pre-configured for the at least one UE, a first indication of whether to pre-configure a first-tier of neighboring cells or a second-tier of neighboring cells for the at least one UE, a distance of cells or areas from a serving cell to be pre-configured for the at least one UE, a second indication of whether to pre-configure PL for the at least one UE, a third indication of whether to pre-configure a beam spatial relation for the at least one UE, a fourth indication of whether to pre-configure a TA timer for the at least one UE, a fifth indication of whether to pre-configure an RSRP-change threshold for the at least one UE, or a combination thereof. The SRS pre-configuration request component 197 may further be configured to receive, from the second network entity, the set of SRS pre-configurations for the at least one UE that meets the set of criteria. The SRS pre-configuration request component 197 may be within the processor 2312. The SRS pre-configuration request component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2360 may include a variety of components configured for various functions. In one configuration, the network entity 2360 may include means for transmitting, for a second network entity, a request to generate a set of SRS pre-configurations for at least one UE according to a set of criteria, where the set of criteria includes: an interference threshold for SRS interference, a number of cells or areas to be pre-configured for the at least one UE, a first indication of whether to pre-configure a first-tier of neighboring cells or a second-tier of neighboring cells for the at least one UE, a distance of cells or areas from a serving cell to be pre-configured for the at least one UE, a second indication of whether to pre-configure PL for the at least one UE, a third indication of whether to pre-configure a beam spatial relation for the at least one UE, a fourth indication of whether to pre-configure a TA timer for the at least one UE, a fifth indication of whether to pre-configure an RSRP-change threshold for the at least one UE, or a combination thereof. The network entity 2360 may further include means for receiving, from the second network entity, the set of SRS pre-configurations for the at least one UE that meets the set of criteria. The means may be the SRS pre-configuration request component 197 of the network entity 2360 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network entity, including: configuring, for a user equipment (UE) in a radio resource control (RRC) inactive mode or RRC idle mode, a set of sounding reference signal (SRS) pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof; and transmitting, for the UE, an indication of the set of SRS pre-configurations.

Aspect 2 is the method of aspect 1, where each SRS pre-configuration in the set of SRS pre-configurations is associated with an expiration timer.

Aspect 3 is the method of aspect 2, further including: receiving, from the UE, a request for one or more new or updated SRS-reconfigurations after an expiration of the expiration timer for one or more SRS pre-configurations in the set of SRS pre-configurations.

Aspect 4 is the method of any of aspects 1 to 3, where the resource overhead corresponds to an SRS periodicity, a number of symbols for an SRS, a bandwidth, or a combination thereof.

Aspect 5 is the method of any of aspects 1 to 4, where the second set of cells is farther away from the UE compared to the first set of cells or the second set of cells has a lower probability on which to be camped by the UE compared to the first set of cells.

Aspect 6 is the method of any of aspects 1 to 5, where the first set of cells includes an initial cell on which the UE is camped and one or more neighbor cells that are adjacent to the initial cell.

Aspect 7 is the method of any of aspects 1 to 6, further including: identifying at least one first cell of the first set of cells or at least one second cell of the second set of cells based on one or more previous mobility patterns of the UE.

Aspect 8 is the method of any of aspects 1 to 7, where transmitting the set of SRS pre-configurations includes broadcasting the set of SRS pre-configurations to a plurality of UEs including the UE.

Aspect 9 is the method of aspect 8, where each SRS pre-configuration in the set of SRS pre-configurations is associated with an SRS configuration identification (ID).

Aspect 10 is the method of any of aspects 8 to 9, further including: ordering or prioritizing one or more SRS pre-configurations in the set of SRS pre-configurations based on at least one condition associated with the one or more SRS pre-configurations.

Aspect 11 is the method of aspect 10, where the at least one condition includes: whether the one or more SRS pre-configurations have a high usage, whether the one or more SRS pre-configurations have a collision history, whether the one or more SRS pre-configurations are causing interference, or a combination thereof.

Aspect 12 is the method of any of aspects 1 to 11, where the network entity is a location management function (LMF), the method further including: transmitting, for a second network entity, a request to generate the set of SRS pre-configurations for the UE according to a set of criteria; and receiving, from the second network entity, the set of SRS pre-configurations for the UE that meets the set of criteria.

Aspect 13 is the method of aspect 12, where the set of criteria includes: an interference threshold for SRS interference, a number of cells or areas to be pre-configured for the UE, a first indication of whether to pre-configure a first-tier of neighboring cells or a second-tier of neighboring cells for the UE, a distance of cells or areas from a serving cell to be pre-configured for the UE, a second indication of whether to pre-configure pathloss (PL) for the UE, a third indication of whether to pre-configure a beam spatial relation for the UE, a fourth indication of whether to pre-configure a timing advance (TA) timer for the UE, a fifth indication of whether to pre-configure a reference signal received power (RSRP)-change threshold for the UE, or a combination thereof

Aspect 14 is an apparatus for wireless communication at a network entity, including: a memory; and at least one processor coupled to the memory and, based at least in part on information stored in the memory, the at least one processor is configured to implement any of aspects 1 to 13.

Aspect 15 is the apparatus of aspect 14, further including at least one of a transceiver or an antenna coupled to the at least one processor.

Aspect 16 is an apparatus for wireless communication including means for implementing any of aspects 1 to 13.

Aspect 17 is a computer-readable medium (e.g., a non-transitory computer-readable medium) storing computer executable code, where the code when executed by a processor causes the processor to implement any of aspects 1 to 13.

Aspect 18 is a method of wireless communication at a user equipment (UE), including: receiving, from a network entity, a set of sounding reference signal (SRS) pre-configurations, where the set of SRS pre-configurations includes at least one first SRS pre-configuration which the UE applies for a transmission of a first set of SRSs when the UE is camped on a first set of cells, and where the set of SRS pre-configurations includes at least one second SRS pre-configuration which the UE applies for a transmission of a second set of SRSs when the UE is camped on a second set of cells, where (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof; and transmitting the first set of SRSs or the second set of SRSs based on the set of SRS pre-configurations when the UE is in a radio resource control (RRC) inactive mode or RRC idle mode.

Aspect 19 is the method of aspect 18, where each SRS pre-configuration in the set of SRS pre-configurations is associated with an expiration timer.

Aspect 20 is the method of aspect 19, further including: transmitting, to the first network entity, a request for one or more new or updated SRS-reconfigurations after an expiration of the expiration timer for one or more SRS pre-configurations in the set of SRS pre-configurations.

Aspect 21 is the method of aspect 19, further including: transmitting, to the first network entity, information indicative of the set of SRS pre-configurations, where the information includes at least one of: a time of each SRS pre-configuration in the set of SRS pre-configurations, a date of each SRS pre-configuration in the set of SRS pre-configurations, an identification (ID) of each SRS pre-configuration in the set of SRS pre-configurations.

Aspect 22 is the method of aspect 21, where the resource overhead corresponds to an SRS periodicity, a number of symbols for an SRS, a bandwidth, or a combination thereof.

Aspect 23 is the method of any of aspects 18 to 22, where the second set of cells is farther away from the UE compared to the first set of cells or the second set of cells has a lower probability on which to be camped by the UE compared to the first set of cells.

Aspect 24 is the method of any of aspects 18 to 23, where the first set of cells includes an initial cell on which the UE is camped and one or more neighbor cells that are adjacent to the initial cell.

Aspect 25 is the method of any of aspects 18 to 24, where transmitting the second set of SRSs based on the set of SRS pre-configurations includes: selecting, randomly or based on a pattern, one SRS pre-configuration from the at least one second SRS pre-configuration; and transmitting the second set of SRSs based on the selected one SRS pre-configuration.

Aspect 26 is the method of any of aspects 18 to 25, where each SRS pre-configuration in the set of SRS pre-configurations is associated with an SRS configuration identification (ID).

Aspect 27 is the method of aspect 26, further including: selecting the at least one first SRS pre-configuration or the at least one second SRS pre-configuration from the set of SRS pre-configurations based on the SRS configuration ID being associated with the at least one first SRS pre-configuration or the at least one second SRS pre-configuration.

Aspect 28 is an apparatus for wireless communication at a UE, including: a memory; and at least one processor coupled to the memory and, based at least in part on information stored in the memory, the at least one processor is configured to implement any of aspects 18 to 27.

Aspect 29 is the apparatus of aspect 28, further including at least one of a transceiver or an antenna coupled to the at least one processor.

Aspect 30 is an apparatus for wireless communication including means for implementing any of aspects 18 to 27.

Aspect 31 is a computer-readable medium (e.g., a non-transitory computer-readable medium) storing computer executable code, where the code when executed by a processor causes the processor to implement any of aspects 18 to 27.

Aspect 32 is a method of wireless communication at a first network entity, including: transmitting, for a second network entity, a request to generate a set of sounding reference signal (SRS) pre-configurations for at least one user equipment (UE) according to a set of criteria, where the set of criteria includes: an interference threshold for SRS interference, a number of cells or areas to be pre-configured for the at least one UE, a first indication of whether to pre-configure a first-tier of neighboring cells or a second-tier of neighboring cells for the at least one UE, a distance of cells or areas from a serving cell to be pre-configured for the at least one UE, a second indication of whether to pre-configure pathloss (PL) for the at least one UE, a third indication of whether to pre-configure a beam spatial relation for the at least one UE, a fourth indication of whether to pre-configure a timing advance (TA) timer for the at least one UE, a fifth indication of whether to pre-configure a reference signal received power (RSRP)-change threshold for the at least one UE, or a combination thereof; and receiving, from the second network entity, the set of SRS pre-configurations for the at least one UE that meets the set of criteria.

Aspect 33 is an apparatus for wireless communication at a first network entity, including: a memory; and at least one processor coupled to the memory and, based at least in part on information stored in the memory, the at least one processor is configured to implement aspect 32.

Aspect 34 is the apparatus of aspect 28, further including at least one of a transceiver or an antenna coupled to the at least one processor.

Aspect 35 is an apparatus for wireless communication including means for implementing aspect 32.

Aspect 36 is a computer-readable medium (e.g., a non-transitory computer-readable medium) storing computer executable code, where the code when executed by a processor causes the processor to implement aspect 32.

1. An apparatus for wireless communication at a network entity, comprising:
a memory; and
at least one processor coupled to the memory, and the at least one processor is configured to:
configure, for a user equipment (UE) in a radio resource control (RRC) inactive mode or RRC idle mode, a set of sounding reference signal (SRS) pre-configurations, wherein the set of SRS pre-configurations includes at least one first SRS pre-configuration which the UE applies for a transmission of a first set of SRSs when the UE is camped on a first set of cells, and wherein the set of SRS pre-configurations includes at least one second SRS pre-configuration which the UE applies for a transmission of a second set of SRSs when the UE is camped on a second set of cells, wherein (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof; and
transmit, for the UE, an indication of the set of SRS pre-configurations.

2. The apparatus of claim 1, wherein each SRS pre-configuration in the set of SRS pre-configurations is associated with an expiration timer.

3. The apparatus of claim 2, wherein the at least one processor is further configured to:
receive, from the UE, a request for one or more new or updated SRS-reconfigurations after an expiration of the expiration timer for one or more SRS pre-configurations in the set of SRS pre-configurations.

4. The apparatus of claim 1, wherein the resource overhead corresponds to an SRS periodicity, a number of symbols for an SRS, a bandwidth, or a combination thereof.

5. The apparatus of claim 1, wherein the second set of cells is farther away from the UE compared to the first set of cells or the second set of cells has a lower probability on which to be camped by the UE compared to the first set of cells.

6. The apparatus of claim 1, wherein the first set of cells includes an initial cell on which the UE is camped and one or more neighbor cells that are adjacent to the initial cell.

7-9. (canceled)

10. The apparatus of claim 1, wherein the at least one processor is further configured to:
order or prioritize one or more SRS pre-configurations in the set of SRS pre-configurations based on at least one condition associated with the one or more SRS pre-configurations.

11. The apparatus of claim 10, wherein the at least one condition includes:
whether the one or more SRS pre-configurations have a high usage,
whether the one or more SRS pre-configurations have a collision history,
whether the one or more SRS pre-configurations are causing interference, or
a combination thereof.

12. The apparatus of claim 1, wherein the network entity is a location management function (LMF), wherein the at least one processor is further configured to:
transmit, for a second network entity, a request to generate the set of SRS pre-configurations for the UE according to a set of criteria; and
receive, from the second network entity, the set of SRS pre-configurations for the UE that meets the set of criteria.

13. The apparatus of claim 12, wherein the set of criteria includes: an interference threshold for SRS interference, a number of cells or areas to be pre-configured for the UE, a first indication of whether to pre-configure a first-tier of neighboring cells or a second-tier of neighboring cells for the UE, a distance of cells or areas from a serving cell to be pre-configured for the UE, a second indication of whether to pre-configure pathloss (PL) for the UE, a third indication of whether to pre-configure a beam spatial relation for the UE, a fourth indication of whether to pre-configure a timing advance (TA) timer for the UE, a fifth indication of whether to pre-configure a reference signal received power (RSRP)-change threshold for the UE, or a combination thereof.

14. (canceled)

15. A method of wireless communication at a network entity, comprising:
configuring, for a user equipment (UE) in a radio resource control (RRC) inactive mode or RRC idle mode, a set of sounding reference signal (SRS) pre-configurations, wherein the set of SRS pre-configurations includes at least one first SRS pre-configuration which the UE applies for a transmission of a first set of SRSs when the UE is camped on a first set of cells, and wherein the set of SRS pre-configurations includes at least one second SRS pre-configuration which the UE applies for a transmission of a second set of SRSs when the UE is camped on a second set of cells, wherein (1) the second set of SRSs is associated with less resource overhead compared to the first set of SRSs, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof; and
transmitting, for the UE, an indication of the set of SRS pre-configurations.

16. (canceled)

17. The method of claim 15, wherein transmitting the set of SRS pre-configurations comprises broadcasting the set of SRS pre-configurations to a plurality of UEs including the UE, wherein the method further comprises:
ordering or prioritizing one or more SRS pre-configurations in the set of SRS pre-configurations based on at least one condition associated with the one or more SRS pre-configurations.

18. An apparatus for wireless communication at a user equipment (UE), comprising:
a memory; and
at least one processor coupled to the memory, and the at least one processor is configured to:
receive, from a network entity, a set of sounding reference signal (SRS) pre-configurations, wherein the set of SRS pre-configurations includes at least one first SRS pre-configuration which the UE applies for a transmission of a first set of SRSs when the UE is camped on a first set of cells, and wherein the set of SRS pre-configurations includes at least one second SRS pre-configuration which the UE applies for a transmission of a second set of SRSs when the UE is camped on a second set of cells, wherein (1) the second set of SRSs is associated with less resource overhead compared to the first set of SRS resources, (2) the first set of SRSs is orthogonal to a third set of SRSs transmitted by a first set of UEs within the first set of cells and the second set of SRSs is not orthogonal to a fourth set of SRSs transmitted by a second set of UEs within the second set of cells, (3) the at least one second SRS pre-configuration includes more SRS pre-configurations than the at least one first SRS pre-configuration, or (4) a combination thereof; and
transmit the first set of SRSs or the second set of SRSs based on the set of SRS pre-configurations when the UE is in a radio resource control (RRC) inactive mode or RRC idle mode.

19. (canceled)

20. The apparatus of claim 18, wherein the at least one processor is further configured to:
transmit, to the first network entity, a request for one or more new or updated SRS-reconfigurations after an expiration of the expiration timer for one or more SRS pre-configurations in the set of SRS pre-configurations.

21. The apparatus of claim 18, wherein the at least one processor is further configured to:
transmit, to the first network entity, information indicative of the set of SRS pre-configurations, wherein the information includes at least one of: a time of each SRS pre-configuration in the set of SRS pre-configurations, a date of each SRS pre-configuration in the set of SRS pre-configurations, an identification (ID) of each SRS pre-configuration in the set of SRS pre-configurations.

22. (canceled)

23. The apparatus of claim 18, wherein the second set of cells is farther away from the UE compared to the first set of cells or the second set of cells has a lower probability on which to be camped by the UE compared to the first set of cells.

24. (canceled)

25. The apparatus of claim 18, wherein to transmit the second set of SRSs based on the set of SRS pre-configurations, the at least one processor is configured to:
select, randomly or based on a pattern, one SRS pre-configuration from the at least one second SRS pre-configuration; and
transmit the second set of SRSs based on the selected one SRS pre-configuration.

26. (canceled)

27. The apparatus of claim 26, wherein the at least one processor is further configured to:
select the at least one first SRS pre-configuration or the at least one second SRS pre-configuration from the set of SRS pre-configurations based on the SRS configuration ID being associated with the at least one first SRS pre-configuration or the at least one second SRS pre-configuration.

28. (canceled)

29. An apparatus for wireless communication at a first network entity, comprising:
a memory; and
at least one processor coupled to the memory, and the at least one processor is configured to:
transmit, for a second network entity, a request to generate a set of sounding reference signal (SRS) pre-configurations for at least one user equipment (UE) according to a set of criteria, wherein the set of criteria includes: an interference threshold for SRS interference, a number of cells or areas to be pre-configured for the at least one UE, a first indication of whether to pre-configure a first-tier of neighboring cells or a second-tier of neighboring cells for the at least one UE, a distance of cells or areas from a serving cell to be pre-configured for the at least one UE, a second indication of whether to pre-configure pathloss (PL) for the at least one UE, a third indication of whether to pre-configure a beam spatial relation for the at least one UE, a fourth indication of whether to pre-configure a timing advance (TA) timer for the at least one UE, a fifth indication of whether to pre-configure a reference signal received power (RSRP)-change threshold for the at least one UE, or a combination thereof; and
receive, from the second network entity, the set of SRS pre-configurations for the at least one UE that meets the set of criteria.

30. The apparatus of claim 29, further comprising a transceiver coupled to the at least one processor, wherein to transmit the request, the at least one processor is configured to transmit, via the transceiver, the request, and wherein to receive the set of SRS pre-configurations, the at least one processor is configured to receive, via the transceiver, the set of SRS pre-configurations.
